(19) United States
(12) Patent Application Publication
(10) Pub. No.: US 2026/0056436 A1
(43) Pub. Date: Feb. 26, 2026

(54) Display Device

(71) Applicant: LG Display Co., Ltd., Seoul (KR)

(72) Inventors: Jeon Phill Han, Paju-si (KR); Seung Han Paek, Paju-si (KR); Kyung Jae Yoon, Paju-si (KR); Yu Cheol Yang, Paju-si (KR); Nam Woo Kim, Paju-si (KR)

(21) Appl. No.: 18/987,319

(22) Filed: Dec. 19, 2024

(30) Foreign Application Priority Data
Aug. 26, 2024 (KR) 10-2024-0114426

(51) Int. Cl. G02F 1/1362; G02F 1/1368

(52) U.S. Cl. CPC G02F 1/136286; G02F 1/136209; G02F 1/136222; G02F 1/1368

(57) ABSTRACT

A display device includes a first substrate including a display area and a non-display area having a bending area, a second substrate disposed apart from the first substrate in the display area, a sub-substrate disposed to face a lower portion of the first substrate while the bending area of the non-display area is disposed therebetween, an etch stopper disposed on the first substrate and the sub-substrate to overlap the bending area, a link line disposed on an upper portion of the etch stopper, and a bump pattern disposed on an upper portion of the link line.

### CROSS-REFERENCE TO RELATED APPLICATION

This application claims priority to and the benefit of Republic of Korea Patent Application No. 10-2024-0114426, filed on Aug. 26, 2024, which is hereby incorporated by reference in its entirety.

### BACKGROUND

### 1. Field of the Invention

The present disclosure relates to a display device.

### 2. Discussion of Related Art

Generally, display devices are widely used as display screens of various electronic devices such as a mobile communication terminal, an electronic organizer, an electronic book, a portable multimedia player (PMP), a navigation device, an ultramobile personal computer (UMPC), a mobile phone, a tablet PC, a watch phone, an electronic pad, a wearable device, a portable information device, a vehicle control display device, a television, a laptop, and a monitor.

In recent years, research and development have been carried out on display devices that can implement the maximum screen size by reducing a bezel area, where an image is not displayed, within the same display panel size.

### SUMMARY

The present disclosure is directed to providing a display device that can prevent or at least reduce cracks in lines and damage to an etch stopper caused by an external force when etching is performed on a substrate located in a bending area of the display device.

Objectives of the present disclosure are not limited to the above-mentioned objective, and other unmentioned objectives should be clearly understood by those of ordinary skill in the art from the description below.

One embodiment of the present disclosure provides a display device including a first substrate including a display area and a non-display area having a bending area, a second substrate disposed apart from the first substrate in the display area, a sub-substrate disposed to face a lower portion of the first substrate while the bending area of the non-display area is disposed therebetween, an etch stopper disposed on the first substrate and the sub-substrate to overlap the bending area, a link line disposed on an upper portion of the etch stopper, and a bump pattern disposed on an upper portion of the link line.

Another embodiment of the present disclosure provides a display device including a first substrate including a display area and a non-display area having a bending area, a second substrate disposed apart from the first substrate in the display area, a liquid crystal layer disposed between the first and second substrates in the display area, a sub-substrate divided from the first substrate while the bending area is disposed therebetween, an etch stopper disposed on the first substrate and the sub-substrate that overlap the bending area, a link line disposed on an upper portion of the etch stopper, a planarization layer disposed on an upper portion of the link line, and a bump pattern disposed on an upper portion of the planarization layer.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a schematic diagram of a display device according to one embodiment of the present disclosure;

FIG. 2 is an enlarged plan view of portion A of FIG. 1 according to one embodiment of the present disclosure;

FIG. 3 is a cross-sectional view along line I-I′ of FIG. 2 according to one embodiment of the present disclosure;

FIG. 4 is an enlarged cross-sectional view of portion B of FIG. 3 according to one embodiment of the present disclosure;

FIGS. 5A to 5C are cross-sectional views of a process of fabricating the display device according to one embodiment of the present disclosure;

FIG. 6 is a cross-sectional view along line I-I′ of FIG. 2 according to another embodiment of the present disclosure;

FIG. 7 is an enlarged cross-sectional view of portion C of FIG. 6 according to one embodiment of the present disclosure;

FIGS. 8A to 8C are cross-sectional views of a process of fabricating the display device according to another embodiment of the present disclosure;

FIG. 9 is a cross-sectional view along line I-I′ of FIG. 2 according to still another embodiment of the present disclosure;

FIG. 10 is an enlarged cross-sectional view of portion D of FIG. 9 according to one embodiment of the present disclosure;

FIGS. 11A to 11C are cross-sectional views of a process of fabricating the display device according to still another embodiment of the present disclosure; and

FIG. 12 is a cross-sectional view of a display device in which a bending area is bent according to one embodiment of the present disclosure.

### DETAILED DESCRIPTION

Advantages and features of the present disclosure and a method of achieving the same should become clear with embodiments described in detail below with reference to the accompanying drawings. However, the present disclosure is not limited to the embodiments disclosed below and may be implemented with a variety of different forms. The present embodiments are merely provided to allow those skilled in the art to completely understand the scope of the present disclosure, and the present disclosure is defined only by the scope of the claims.

The figures, dimensions, ratios, angles, numbers, and the like disclosed in the drawings for describing the embodiments of the present disclosure are merely illustrative and are not limited to matters shown in the present disclosure. Further, in describing the present disclosure, detailed descriptions of well-known technologies will be omitted when it is determined that they may unnecessarily obscure the gist of the present disclosure.

When ‘including’, ‘to have’, and ‘comprising’ mentioned in the present disclosure are used, other parts may be added unless ‘only’ is used. In the case of expressing a component in a singular form, it includes the case of including the plural unless otherwise specified. In interpreting components, it is interpreted as including the scope of error even if there is no explicit description.

In the case of a description of a positional relationship, for example, if the positional relationship of the two parts is described as ‘˜top’, ‘˜above’, ‘˜bottom’, ‘˜side’, etc., one or more other parts may be located between the two parts unless ‘right’ or ‘direct’ is used. Any element or layer referred to as on or over another element or layer includes the case of being directly on the other element or layer, or interposing another layer or other element between the elements or layers.

In addition, although first, second, and the like are used to describe various components, these components are not limited by these terms. These terms are used only to distinguish one component from another. Thus, the first component mentioned below may be the second component within the technical idea of the present disclosure.

Throughout the disclosure, the same reference numerals refer to the same components.

The size and thickness of each component shown in the drawings are shown for convenience of description, and the present disclosure is not necessarily limited to the size and thickness of the component shown in the drawings.

Features of each of the various embodiments of the present disclosure may be partially or entirely coupled or combined with each other, technically various interworking and driving are possible, and each of the embodiments may be independently implemented with respect to each other or may be implemented together in a related relationship.

In the present disclosure, a “device” may be a display device, such as a liquid crystal module (LCM) or an organic light emitting diode (OLED) display module including a display panel and a driving part for driving the display panel. In addition, the “device” may be a set electronic apparatus or a set device or set apparatus such as an equipment apparatus such as a laptop, a television, a monitor, an automotive apparatus, or other forms of vehicles, and a mobile electronic apparatus such as a smartphone or an electronic pad, which are complete products or final products that include an LCM or an OLED display module.

Accordingly, a display device in the present disclosure may refer to a display device itself such as an LCM or an OLED display module or a set device or set apparatus which is an application product or an end product including an LCM or an OLED display module.

Moreover, in some embodiments, an LCM or an OLED display module including a display panel, a driving part, and the like may be referred to as a “display device,” and an electronic apparatus which is a complete product or final product including an LCM or an OLED display module may separately be referred to as “set device” or “set apparatus. ” For example, a display device may include a display panel made of liquid crystal (LC) or an OLED and a source printed circuit board (PCB) which is a controller for driving the display panel. A set device may further include a set PCB which is a set controller electrically connected to the source PCB to drive the entire set device.

The term “display device” used in embodiments of the present disclosure may refer to any type of display device such as a liquid crystal display (LCD) device, an OLED display device, and an electroluminescent display device. However, the present disclosure is not limited thereto.

Different features of various embodiments of the present disclosure may be partially or entirely combined with each other, various types of interlocking and driving are possible technically, and different embodiments may be carried out independently from each other or carried out together in combination.

Hereinafter, various embodiments of the present invention will be described in detail with reference to the accompanying drawings. Components illustrated in the drawings may have scales different from the actual scales thereof for the sake of convenience of description and are thus not limited to the scales illustrated in the drawings.

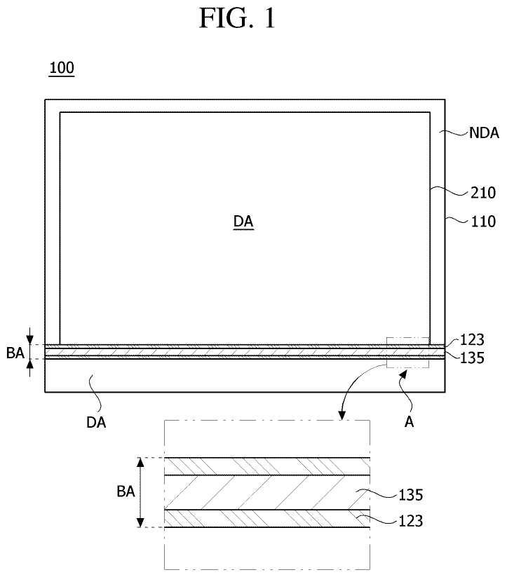

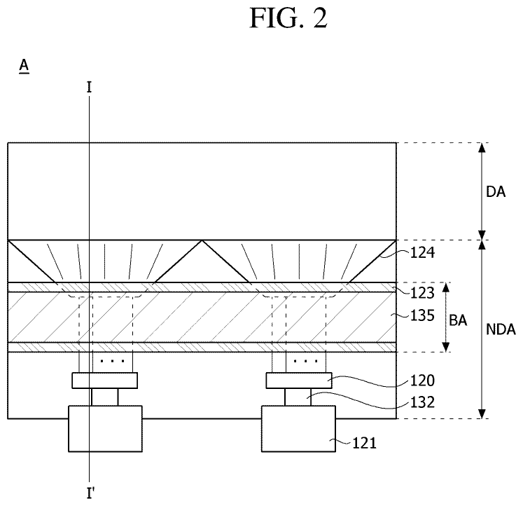

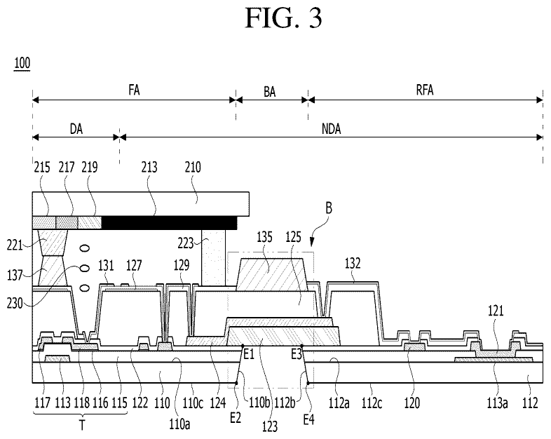

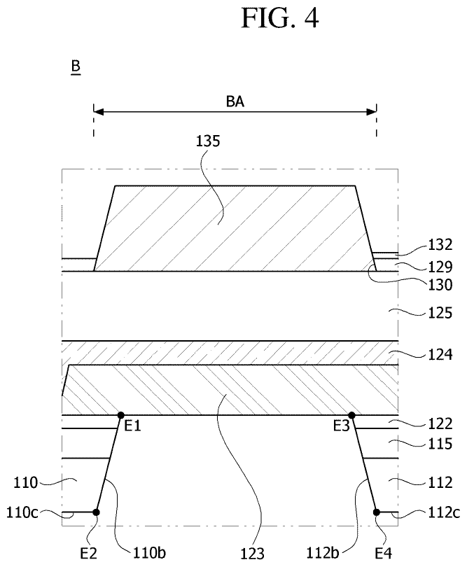

FIG. 1 is a schematic diagram of a display device according to one embodiment of the present disclosure. FIG. 2 is an enlarged plan view of portion A of FIG. 1 according to one embodiment of the present disclosure. FIG. 3 is a cross-sectional view along line I-I′ of FIG. 2 according to one embodiment of the present disclosure. FIG. 4 is an enlarged cross-sectional view of portion B of FIG. 3 according to one embodiment of the present disclosure.

A display device 100 of the present disclosure may be an LCD device, a plasma display panel (PDP) device, a field emission display (FED) device, an electroluminescence display (ELD) device, an OLED display device, or the like, but in the present disclosure, an LCD device using a backlight unit, a micro-LED (μ-LED), or other light sources among the display devices will be described as an example of the display device 100. However, the present disclosure is not limited thereto.

Referring to FIGS. 1 to 3, the display device 100 according to an embodiment of the present disclosure includes a display area DA and a non-display area NDA. In addition, the non-display area NDA may include a bending area BA and a rear flat area RFA.

The display device 100 according to one embodiment of the present disclosure may include a first glass substrate 110 and a second glass substrate 210 vertically disposed to face each other at a predetermined gap in the display area DA. In addition, the display device 100 may further include a sub-glass substrate 112 disposed to face a lower surface of the first glass substrate 110 when the bending area BA is bent.

Here, a thin film transistor T, a gate line, a data line, and a pixel electrode 131 may be disposed at an upper portion of a first upper surface 110a of the first glass substrate 110.

Red, green, and blue color filter layers 215, 217, and 219 may be disposed on an upper portion of the second glass substrate 210 that is a color filter array substrate disposed to face the first glass substrate 110, which is a thin film transistor array substrate, at a predetermined gap.

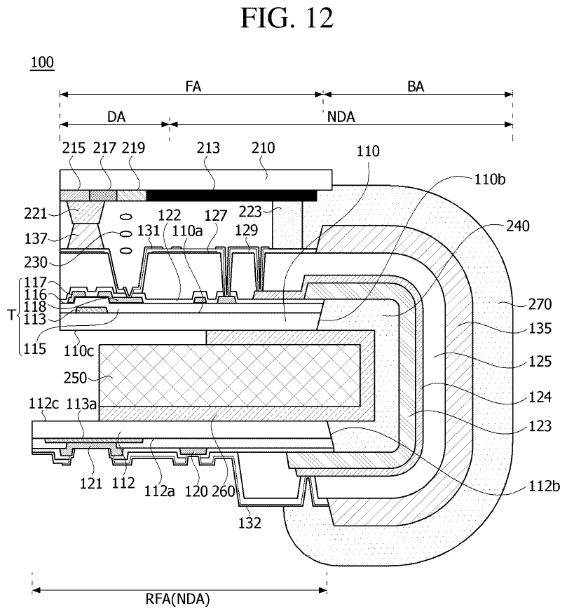

Moreover, a liquid crystal layer 230 may be filled between the first glass substrate 110 and the second glass substrate 210 located in the display area DA. In addition, a light source part 250 (see FIG. 12) configured to emit light toward an upper portion of the first glass substrate 110 may be disposed between the first glass substrate 110 and the sub-glass substrate 112 disposed to face a lower portion of the first glass substrate 110 through bending of the bending area BA while the bending area BA of the non-display area NDA is disposed therebetween.

The first and second glass substrates 110 and 210 and the sub-glass substrate 112 may include a glass material. The first glass substrate 110 and the sub-glass substrate 112 may have a thickness ranging from 0.01 mm to 1.0 mm to maintain flatness of the first upper surface 110a of the first glass substrate 110 and a second upper surface 112a of the sub-glass substrate 112 or to block penetration of moisture or oxygen into the display device. However, the thickness of the first glass substrate 110 and the sub-glass substrate 112 is not limited thereto and may be changed according to design conditions of the display device.

The display area DA is an area where an image is displayed and may include a plurality of pixels. The display area DA may be supported by the first upper surface 110a of the first glass substrate 110.

The display area DA may include a plurality of pixels. The plurality of pixels may be disposed in a matrix form and each of the plurality of pixels may include sub-pixels. The display area DA may have a substantially rectangular shape. Moreover, embodiments of the present disclosure are not limited thereto, and the display area DA may have any other polygonal shape. In addition, for example, the display area DA may have a triangular shape, a pentagonal shape, or a hexagonal shape depending on the shape of the display device. In the present disclosure, for the sake of convenience of description, the display area DA having a rectangular shape according to the display device 100 having a rectangular shape will be described.

The non-display area NDA may be disposed adjacent to the display area. In addition, a device and a circuit line for driving the display area DA may be disposed in the non-display area NDA. More specifically, the non-display area NDA is an area surrounding the display area DA, and a device and a circuit line for driving the display area DA may be disposed in the non-display area NDA.

The bending area BA may be defined as an area provided to allow one portion of the display device 100 to be bent. Accordingly, the display device 100 according to one example of the present disclosure may be folded to have a predetermined radius of curvature according to the bending of the bending area BA.

As in FIG. 3, the display device 100 according to one embodiment of the present disclosure may be defined by a flat area FA, the bending area BA, and the rear flat area RFA. Since the bending area BA is the same as described above, a description thereof will be omitted.

The flat area FA may be defined as an area that overlaps the first upper surface 110a of the first glass substrate 110. In addition, the flat area FA may overlap the display area DA. Moreover, the flat area FA may partially overlap the non-display area NDA. In the non-display area NDA surrounding the display area DA, the non-display area NDA disposed close to the display area DA may be an area overlapping the flat area FA.

The rear flat area RFA may be defined as an area that overlaps the second upper surface 112a of the sub-glass substrate 112. In addition, the rear flat area RFA may be defined as an area that does not overlap the bending area BA. A chip-on-glass (COG) 120 and a flexible printed circuit (FPC) 113a may be provided in the rear flat area RFA.

The display device 100 may include various additional elements for generating various signals or driving a plurality of sub-pixels in the display area DA. Additional elements for driving the sub-pixels may include an inverter circuit, a multiplexer, an electrostatic discharge (ESD) circuit, and the like. The display device 100 may also include additional elements associated with functions other than driving sub-pixels. For example, the display device 100 may include additional elements providing a touch detection function, a user authentication function (e.g., fingerprint recognition), a multi-level pressure detection function, a tactile feedback function, and the like. The additional elements mentioned above may be located in the non-display area NDA or an external circuit connected to a connection interface.

Referring to FIGS. 1 to 3, the first glass substrate 110 may include the display area DA and the non-display area NDA surrounding the display area DA. The non-display area NDA of the first glass substrate 110 may be adjacent to the display area DA and disposed outside of the display area DA.

The display area DA may include a liquid crystal display device. However, the present disclosure is not limited thereto.

Referring to FIGS. 3 and 4, the display device 100 according to one embodiment of the present disclosure may include the first glass substrate 110 including the display area DA and the non-display area NDA, the second glass substrate 210 disposed to face the first glass substrate 110 at a predetermined cell gap, the liquid crystal layer 230 disposed between the first and second glass substrates 110 and 210, and the sub-glass substrate 112 disposed on the lower portion of the first glass substrate 110.

In the display area DA, the thin film transistor T including a gate electrode 113, an active layer 116, a source electrode 117, and a drain electrode 118 may be formed on the upper portion of the first upper surface 110a of the first glass substrate 110.

Moreover, in the non-display area NDA, the COG 120 and the FPC 113a may be formed on an upper portion of the second upper surface 112a of the sub-glass substrate 112.

In addition, in the non-display area NDA, a connection line 132 connected to the COG 120 and a pad part 121 connected to the FPC 113a may be formed on the upper portion of the second upper surface 112a of the sub-glass substrate 112.

A first interlayer insulation film 122 may be formed on the first upper surface 110a of the first glass substrate 110 and the second upper surface 112a of the sub-glass substrate 112. The first interlayer insulation film 122 may be formed on entire surfaces of the first upper surface 110a and the second upper surface 112a.

In the bending area BA of the non-display area NDA, an etch stopper 123 may be disposed on upper portions of the first glass substrate 110 and the sub-glass substrate 112. The etch stopper 123 may be disposed on the first interlayer insulation film 122 laminated on a gate insulation film 115 located in the bending area BA.

Referring to FIGS. 2 and 3, in the bending area BA of the non-display area NDA, a link line 124 may be disposed on an upper surface of the etch stopper 123. Moreover, the link line 124 may be disposed to cover one side surface of the etch stopper. In addition, the link line 124 may be disposed on an upper portion of the first interlayer insulation film 122.

In the bending area BA, one portion of a lower surface of the etch stopper 123 may be exposed due to the first glass substrate 110 and the sub-glass substrate 112 being partially removed. As the first glass substrate 110 and the sub-glass substrate 112 are partially removed, the display device may be bent in the bending area BA. Accordingly, an area where the first glass substrate 110 and the sub-glass substrate 112 are partially removed is an area overlapping the bending area BA.

In an area where one portion of the lower surface of the etch stopper 123 is exposed, a first etching surface 110b may be formed on the first glass substrate 110 located below one side area of the etch stopper 123. In addition, a second etching surface 112b may be formed on the sub-glass substrate 112 located below the other side area of the etch stopper 123.

Moreover, the first glass substrate 110 may include a first lower surface 110c facing the first upper surface 110a. In addition, in the bending area BA, the first glass substrate 110 may further include the first etching surface 110b connecting an end of the first upper surface 110a and an end of the first lower surface 110c.

As in FIGS. 3 and 4, the first glass substrate 110 may include a first end E1 which is a boundary between the first upper surface 110a and the first etching surface 110b and a second end E2 which is a boundary between the first etching surface 110b and the first lower surface 110c.

A slope of the first etching surface 110b may be defined based on an inclined surface connecting the first end E1 and the second end E2. Although the first etching surface 110b is illustrated as having an inclined tapered surface in FIG. 3, the embodiment of the present disclosure is not limited thereto.

The sub-glass substrate 112 may include the second etching surface 112b provided to overlap the bending area BA.

The sub-glass substrate 112 may include the second upper surface 112a and a second lower surface 112c facing the second upper surface 112a. In addition, in the bending area BA, the sub-glass substrate 112 may further include the second etching surface 112b connecting an end of the second upper surface 112a and an end of the second lower surface 112c.

Moreover, as shown in FIGS. 3 and 4, the sub-glass substrate 112 may include a third end E3, which is a boundary between the second upper surface 112a and the second etching surface 112b, and a fourth end E4, which is a boundary between the second etching surface 112b and the second lower surface 112c.

The first etching surface 110b of the first glass substrate 110 and the second etching surface 112b of the sub-glass substrate 112 may be referred to as having a reverse-tapered shape or an undercut structure. Here, the reverse-tapered shape refers to a case in which a distance between the first end E1 and the third end E3 is shorter than a distance between the second end E2 and the fourth end E4 as shown in FIG. 4.

The etch stopper 123 may be disposed to overlap the bending area BA. For example, the etch stopper 123 may be disposed to overlap the bending area BA. The bending area BA may include a lower surface of the etch stopper 123, the first etching surface 110b provided on a side surface of the first glass substrate 110, and the second etching surface 112b provided on a side surface of the sub-glass substrate 112.

The etch stopper 123 may be a configuration for preventing or at least reducing damage to the display device caused by etching when an etching process is performed on the lower surfaces of the substrates 110 and 112 to form the first glass substrate 110 and the sub-glass substrate 112. For example, in the bending area BA, when an etching process is performed to remove the first glass substrate 110 and the sub-glass substrate 112, the etch stopper 123 may prevent damage from occurring to structures formed on the first glass substrate 110 and the sub-glass substrate 112. Accordingly, the etch stopper 123 may be disposed to overlap the bending area BA of the display device.

In the etching process, an insulation layer disposed between the first glass substrate 110, the sub-glass substrate 112, and the etch stopper 123 may also be removed. For example, referring to FIG. 3, the gate insulation film 115 and the first interlayer insulation film 122 disposed between the first glass substrate 110, the sub-glass substrate 112, and the etch stopper 123 may also be removed via the etching process. As illustrated in FIG. 3, in the bending area BA, the first glass substrate 110, the sub-glass substrate 112, the gate insulation film 115, and the first interlayer insulation film 122 that are disposed at a lower portion of the etch stopper 123 may be removed via the etching process.

As illustrated in FIG. 3, the etch stopper 123 may include the bending area BA. In addition, the etch stopper 123 may overlap the first upper surface 110a of the first glass substrate 110 that extends to one side of the bending area BA and may overlap the second upper surface 112a of the sub-glass substrate 112 that extends to the other side of the bending area BA.

Here, the etch stopper 123 may be made of an inorganic or organic material. Alternatively, the etch stopper 123 may be made of a double layer structure of an inorganic material and an organic material. However, the present disclosure is not limited thereto. Specifically, the etch stopper 123 may be made of a material that has resistance to an etchant. For example, an etchant including nitric acid (HNO3) or hydrofluoric acid (HF) may be used as an etchant for glass etching in a wet etching process. The etch stopper 123 may be made of one of a metal and an organic material.

The etch stopper 123 may include at least one of a silicone-based organic material, urethane, polyimide, and photo acryl. Alternatively, the etch stopper 123 may include at least one of chromium (Cr), aluminum (Al), platinum (Pt), gold (Au), and nickel (Ni).

The etch stopper 123 may be used as a layer for protecting configurations located at an upper portion of the etch stopper 123 in a process in which the first etching surface 110b of the first glass substrate 110 and the second etching surface 112b of the sub-glass substrate 112 are formed. For example, the etch stopper 123 may be used as a layer for protecting the link line 124. The etch stopper 123 may have a larger size than areas overlapping the first etching surface 110b of the first glass substrate 110 and the second etching surface 112b of the sub-glass substrate 112 or may have a larger size than an area of the bending area BA.

The etch stopper 123 according to one embodiment of the present disclosure may prevent damage from occurring to the display device due to an etchant used in a glass etching process for forming the first etching surface 110b of the first glass substrate 110 and the second etching surface 112b of the sub-glass substrate 112. The etch stopper 123 may be made of a material having corrosion resistance (or tolerance) to an etchant used in a substrate etching process.

In this way, in the display device 100 according to one embodiment of the present disclosure, damage to the display device 100 due to performing the glass etching process for forming the first etching surface 110b of the first glass substrate 110 and the second etching surface 112b of the sub-glass substrate 112 may be prevented due to the etch stopper 123.

The etch stopper 123 may be defined as an etch stop pattern, an etch barrier pattern, an etch mask pattern, or the like.

Moreover, in consideration of an etching process margin for forming the first etching surface 110b of the first glass substrate 110 and the second etching surface 112b of the sub-glass substrate 112, the etch stopper 123 may be formed to also overlap areas extending to one side and the other side of the bending area BA. Specifically, the etch stopper 123 may be formed so that a predetermined area thereof overlaps the first upper surface 110a of the first glass substrate 110 and the second upper surface 112a of the sub-glass substrate 112. When the etch stopper 123 is formed to extend to one side and the other side of the bending area BA, stability with respect to an etching process for forming the first etching surface 110b of the first glass substrate 110 and the second etching surface 112b of the sub-glass substrate 112 may be improved.

A planarization layer 125 may be formed on upper portions of the first glass substrate 110 and the sub-glass substrate 112. For example, the planarization layer 125 may be disposed on the thin film transistor T, the first interlayer insulation film 122 disposed on the thin film transistor, the etch stopper 123 disposed on the first interlayer insulation film 122, and the link line 124 disposed on the etch stopper 123.

A common electrode 127 may be disposed on an upper portion of the planarization layer 125. The common electrode 127 may be formed of a transparent conductive material or an opaque conductive material. For example, the common electrode 127 may be formed of indium tin oxide (ITO), indium zinc oxide (IZO), or another conductive material.

A second interlayer insulation film 129 may be formed on the upper portion of the planarization layer 125 that includes the common electrode 127.

The pixel electrode 131 electrically connected to the drain electrode 118 of the thin film transistor T may be formed on an upper portion of the second interlayer insulation film 129. The pixel electrode 131 may be electrically connected to the drain electrode 118 through a drain contact hole (not illustrated) formed in the first interlayer insulation film 122, the planarization layer 125, and the second interlayer insulation film 129. In addition, the connection line 132 connected to the COG 120 and the pad part 121 may be formed on an upper portion of the sub-glass substrate 112 located in the non-display area NDA. The connection line 132 may be connected to the COG 120 and the pad part 121 through the first interlayer insulation film 122, the planarization layer 125, and the second interlayer insulation film 129, or through a contact hole (not illustrated) formed in the first and second interlayer insulation films 122 and 129.

Moreover, when the first interlayer insulation film 122, the planarization layer 125, and the second interlayer insulation film 129 that are located in the display area DA are etched to form the drain contact hole (not illustrated), a portion of the second interlayer insulation film 129 on the etch stopper 123 located in the bending area BA may be removed, and one portion of the planarization layer 125 may be exposed. For example, when the second interlayer insulation film 129 is made of an inorganic material, and the second interlayer insulation film 129 made of an inorganic material is present in the bending area BA, cracks occur during bending of the bending area BA. Therefore, since the cracks may spread toward the display area DA, a portion of the second interlayer insulation film 129 that is formed in the bending area BA may be removed to block the spreading of the cracks toward the display area DA.

Moreover, referring to FIGS. 3 and 4, a bump pattern 135 may be disposed on an upper portion of the planarization layer 125 on the etch stopper 123 that is located in the bending area BA and from which a portion of the second interlayer insulation film 129 is removed. The bump pattern 135 may be made of an organic material having flexibility or elasticity to prevent an occurrence of cracks caused by stress while being bent. In addition, the bump pattern 135 may be made of an organic material identical to a material of which a column spacer formed on the second glass substrate 210 is formed. However, the present disclosure is not limited thereto.

Accordingly, since the bump pattern 135 is formed on the planarization layer 125 laminated on the upper portion of the etch stopper 123 overlapping the bending area BA, the bump pattern 135 may reinforce the thickness of an organic layer laminated on the etch stopper 123 and thereby prevent or at least reduce an occurrence of cracks in lines, such as link lines 124, while performing etching on the first glass substrate 110 and the sub-glass substrate 112 in the bending area BA and prevent or at least reduce the occurrence of damage to the etch stopper 123 caused by an external force.

Moreover, when forming the bump pattern 135, a sub-bump pattern 137 may be disposed on the second interlayer insulation film 129 located on an upper portion of the thin film transistor T located in the display area DA. Here, as will be described below, the sub-bump pattern 137 may be disposed to overlap and come into contact with a column spacer 221 disposed on the second glass substrate 210, which is a color filter array substrate.

In addition, a first alignment film (not illustrated) for easily inducing liquid crystal alignment may be formed on an upper portion of the pixel electrode 131.

Meanwhile, black matrices 213 may be disposed at predetermined intervals on the second glass substrate 210 disposed to correspond to the first glass substrate 110 of the display area DA while having a predetermined cell gap therebetween.

The black matrices 213 may have a closed loop shape surrounding the display area DA to block light leakage. In addition, the black matrices 213 may also correspond to areas corresponding to the thin film transistor T, the gate line (not illustrated), and the data line (not illustrated) of the first glass substrate 110 to block light leakage. In the display area DA, the black matrices 213 may be disposed in the shape of a matrix.

Accordingly, the black matrices 213 may be disposed between the red, green, and blue color filter layers 215, 217, and 219 to prevent or at least reduce color mixture between the color filter layers 215, 217, and 219.

The red (R), green (G), and blue (B) color filter layers 215, 217, and 219 each configured to filter only light of a specific wavelength band may be disposed between the black matrices 213. The color filter layers 215, 217, and 219 may each include an acryl resin and a pigment. The color filter layers 215, 217, and 219 may be classified into red (R), green (G), and blue (B) according to the type of pigment implementing the colors.

An overcoat layer (not illustrated) may be further formed on the black matrices 213 and the color filter layers 215, 217, and 219. The overcoat layer (not illustrated) may be provided to protect the color filter layers 215, 217, and 219 and improve adhesion through surface planarization of the color filter layers 215, 217, and 219 and may be made of an acrylic resin.

A second alignment film (not illustrated) may be formed on an upper portion of the overcoat layer (not illustrated) to easily induce liquid crystal alignment.

The column spacer 221 may be disposed to overlap an area of the thin film transistor T of the first glass substrate 110 disposed to face the second glass substrate 210 at a predetermined gap on an upper portion of the second alignment film (not illustrated). The column spacer 221 may be disposed to overlap and come into contact with an upper surface of the above-described sub-bump pattern 137.

A seal line 223 may be disposed in the non-display area NDA of the first glass substrate 110 and the second glass substrate 210. Here, the first and second glass substrates 110 and 210 may be bonded by the seal line 223.

The seal line 223 may be disposed on the second interlayer insulation film 129 while spaced apart from the first alignment film (not illustrated) and may be disposed to face the second interlayer insulation film 129 and the black matrices 213. The seal line 223 may be made of a sealant. For example, the sealant may be a photocurable or thermosetting epoxy resin. The seal line 223 serves to form a gap for liquid crystal injection and prevent leakage of injected liquid crystals, and the liquid crystal layer 230 may be disposed at an inner side of the seal line 223.

By the formation of the seal line 223, an LCD device is configured by forming a thermosetting resin of a predetermined pattern on the first glass substrate 110, placing the second glass substrate 210 on the first glass substrate 110, and then pressing and curing the two substrates 110 and 210 to bond the two substrates 110 and 210.

An area in which a predetermined cell gap is formed between the first glass substrate 110 and the second glass substrate 210 may be filled with the liquid crystal layer 230. The liquid crystal layer 230 may include a liquid crystal having an optical anisotropic characteristic.

The display device 100 according to one embodiment of the present disclosure may display a desired image by driving liquid crystal cells using a data voltage supplied to the pixel electrode 131 and a common voltage supplied to the common electrode 127 to adjust light transmittance of the liquid crystal cells.

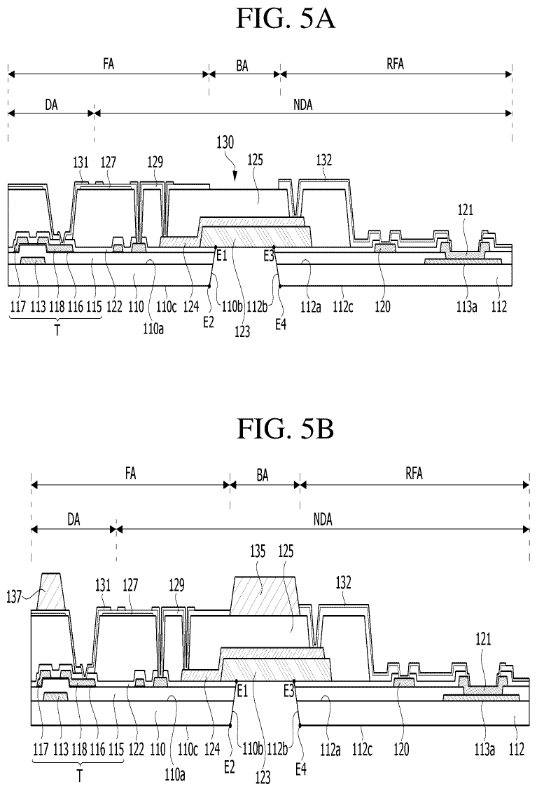

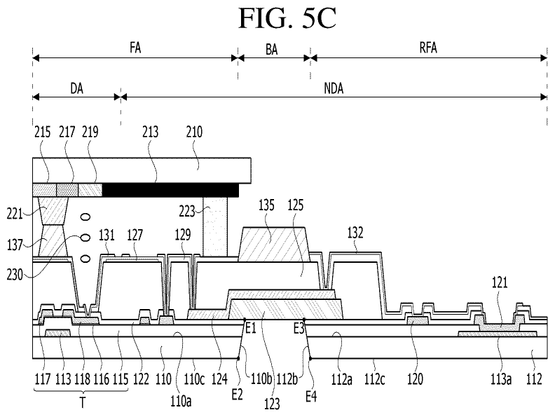

A method of fabricating the display device according to one embodiment of the present disclosure will be described with reference to FIGS. 5A to 5C. Here, processes of placing the etch stopper 123 and the bump pattern 135 on the first glass substrate 110 and the sub-glass substrate 112 overlapping the bending area BA will be mainly described.

FIGS. 5A to 5C are cross-sectional views of a process of fabricating the display device according to one embodiment of the present disclosure.

Referring to FIG. 5A, first, the display area DA, the non-display area NDA, and the bending area BA may be defined in the first glass substrate 110.

Next, the first glass substrate 110 may include a glass material. The first glass substrate 110 may have a thickness ranging from 0.01 mm to 1.0 mm to maintain flatness of the first upper surface 110a of the first glass substrate 110 and the second upper surface 112a of the sub-glass substrate 112 or to block penetration of moisture or oxygen into the display device. However, the thickness of the first glass substrate 110 is not limited thereto and may be changed according to design conditions of the display device.

The display area DA is an area where an image is displayed and may include a plurality of pixels. The display area DA may be supported by the first upper surface 110a of the first glass substrate 110.

The display area DA may include a plurality of pixels. The plurality of pixels may be disposed in a matrix form, and each of the plurality of pixels may include sub-pixels. The display area DA may have a substantially rectangular shape. In addition, embodiments of the present disclosure are not limited thereto, and the display area DA may have any other polygonal shape.

The non-display area NDA is an area surrounding the display area DA, and a device and a circuit line for driving the display area DA may be disposed in the non-display area NDA.

Moreover, the bending area BA may be defined as an area provided to allow one portion of the display device 100 to be bent. The display device 100 according to one example of the present disclosure may be folded to have a predetermined radius of curvature according to the bending of the bending area BA. Here, the first glass substrate 110 may include the display area DA and the non-display area NDA surrounding the display area DA. The non-display area NDA of the first glass substrate 110 may be adjacent to the display area DA and disposed outside of the display area DA. Here, the display area DA may include an LCD device. However, the present disclosure is not limited thereto.

Next, the gate electrode 113, the gate insulation film 115, the active layer 116, the source electrode 117, and the drain electrode 118 may be sequentially formed on an upper portion of the first upper surface 110a of the first glass substrate 110 of the display area DA. Here, the gate electrode 113, the gate insulation film 115, the active layer 116, the source electrode 117, and the drain electrode 118 may constitute the thin film transistor T disposed for each sub-pixel.

Here, the gate insulation film 115 may be made of an inorganic insulation material such as silicon nitride or silicon oxide. The gate insulation film 115 may form a single-layer structure or a multi-layer structure made of an inorganic insulation material.

The active layer 116 may be formed of amorphous silicon (a-Si), polycrystalline silicon (poly-Si), an oxide semiconductor, an organic semiconductor, or the like.

When forming the gate electrode 113, the FPC 113a may also be formed on the upper portion of the second upper surface 112a of the sub-glass substrate 112 of the non-display area NDA. Here, the sub-glass substrate 112 may be a glass substrate divided from the first glass substrate 110 as a lower surface of the first glass substrate 110 located in the bending area BA is etched.

A metal material layer for forming the gate electrode 113, the source electrode 117, and the drain electrode 118 may be made of two or more layers selected from an aluminum (Al) layer, a titanium (Ti) layer, a molybdenum (Mo) layer, and a copper (Cu) layer. As examples of such combinations, an Al layer fitted between Ti layers (Ti/Al/Ti), an Al layer present between upper and lower Mo layers (Mo/Al/Mo), a Cu layer fitted between Ti layers (Ti/Cu/Ti), a Cu layer present between upper and lower Mo layers (Mo/Cu/Mo), and the like may be used. However, the present disclosure is not limited thereto.

When forming the source and drain electrodes 117 and 118, the COG 120 and the pad part 121 which is connected to the FPC 113a may be formed together at the upper portion of the second upper surface 112a of the sub-glass substrate 112 located in the non-display area NDA. Accordingly, the source and drain electrodes 117 and 118, the COG 120, and the pad part 121 that is connected to the FPC 113a may be formed by the same process.

Next, the first interlayer insulation film 122 may be formed on entire surfaces of the first upper surface 110a including the thin film transistor T of the first glass substrate 110 and the second upper surface 112a of the sub-glass substrate 112. The first interlayer insulation film 122 may have a structure on which a single inorganic insulation layer made of SiN or SiOx is laminated or a structure on which multiple inorganic insulation layers made of SiN or SiOx are laminated. However, the present disclosure is not limited thereto.

Here, the first interlayer insulation film 122 may be disposed on an upper portion of the gate insulation film 115 including the source electrode 117 and the drain electrode 118. The first interlayer insulation film 122 may be made of an inorganic insulation material such as SiN or SiOx. In addition, the first interlayer insulation film 122 may be formed of a single-layer structure or a multi-layer structure made of an inorganic insulation material. The first interlayer insulation film 122 may protect the source electrode 117 and the drain electrode 118 of the thin film transistor T.

Then, an organic layer (not illustrated) for forming the etch stopper 123 may be formed on the first interlayer insulation film 122 present on the first glass substrate 110 located in the bending area BA of the non-display area NDA. The organic layer may include at least one of a silicone-based organic material, urethane, polyimide, and photo acryl. However, the present disclosure is not limited thereto.

Moreover, the organic layer may be made of a material that has resistance to a glass etchant. For example, an etchant including nitric acid (HNO3) or hydrofluoric acid (HF) may be used as an etchant for glass etching in a wet etching process. The etch stopper 123 may be made of one of a metal and an organic material instead of being made of an organic insulation layer. The etch stopper 123 may include at least one of chromium (Cr), aluminum (Al), platinum (Pt), gold (Au), and Nickel (Ni).

Next, through an exposure and development process using a photolithography technique, the organic layer (not illustrated) may be selectively removed to remain only in the bending area BA, thereby forming the etch stopper 123. Here, the etch stopper 123 may be disposed to overlap the bending area BA. For example, the etch stopper 123 may be disposed to overlap only the bending area BA.

The etch stopper 123 may be a configuration for preventing damage caused by etching to areas of the display device that overlap the first etching surface 110b and the second etching surface 112b when an etching process necessary to distinguish the first glass substrate 110 and the sub-glass substrate 112 is performed. Accordingly, the etch stopper 123 may be disposed to overlap the bending area BA of the display device.

Here, the etch stopper 123 may include the bending area BA and may overlap the first upper surface 110a of the first glass substrate 110 that extends to one side of the bending area BA and may overlap the second upper surface 112a of the sub-glass substrate 112 that extends to the other side of the bending area BA.

Moreover, the etch stopper 123 may be used as a layer for protecting configurations located at the upper portion of the etch stopper 123, such as a plurality of link lines 124, in a process of forming the first etching surface 110b of the first glass substrate 110 and the second etching surface 112b of the sub-glass substrate 112. The etch stopper 123 may have a larger size than areas overlapping the first etching surface 110b of the first glass substrate 110 and the second etching surface 112b of the sub-glass substrate 112 or may have a larger size than an area of the bending area BA.

In addition, the etch stopper 123 may prevent or at least reduce damage from occurring to the display device due to an etchant being used in a glass etching process for forming the first etching surface 110b of the first glass substrate 110 and the second etching surface 112b of the sub-glass substrate 112. The etch stopper 123 may be made of a material having corrosion resistance (or tolerance) to an etchant used in the glass etching process.

Moreover, the etch stopper 123 may be formed by spraying a material at a set position mechanically using a slit coater, an inkjet, or a dispenser or may be formed via a patterning process using a mask according to the photolithography technique.

In addition, in consideration of a process margin caused by etching in the process of forming the first etching surface 110b of the first glass substrate 110 and the second etching surface 112b of the sub-glass substrate 112, the etch stopper 123 may be formed to also overlap areas extending to one side and the other side of the bending area BA. Specifically, the etch stopper 123 may be formed so that a predetermined area thereof overlaps the first upper surface 110a of the first glass substrate 110 and the second upper surface 112a of the sub-glass substrate 112. Here, when the etch stopper 123 is formed to extend to one side and the other side of the bending area BA, stability with respect to an etching process for forming the first etching surface 110b of the first glass substrate 110 and the second etching surface 112b of the sub-glass substrate 112 may be improved.

Next, the plurality of link lines 124 that may be connected to a plurality of pixel electrodes 131 may be disposed on the upper portion of the first interlayer insulation film 122 across the upper surface and side surfaces of the etch stopper 123.

Then, the planarization layer 125 may be formed on upper portions of the first glass substrate 110 and the sub-glass substrate 112 that include the thin film transistor T of the display area DA and the plurality of link lines 124 of the non-display area NDA.

Here, the planarization layer 125 is a layer for planarizing the upper portion of the first glass substrate 110 and may be formed of an organic insulation material to cover a step difference on an upper portion of the first glass substrate 110. For example, the planarization layer 125 may be made of one or more of polyacrylate resin, epoxy resin, phenolic resin, polyamide resin, polyimide resin, unsaturated polyester resin, polyphenylene resin, polyphenylene sulfide resin, and benzocyclobutene, but is not limited thereto. The planarization layer 125 may be made of a single layer, a double layer, or multiple layers. The planarization layer 125 may be formed with a thickness ranging from 2 μm to 5 μm to sufficiently cover the step difference on the first glass substrate 110.

Then, by selectively patterning the planarization layer 125 through a mask process using the photolithography technique, the first interlayer insulation film 122 and the link lines 124 at the upper portion of the drain electrode 118 of the thin film transistor T may be partially exposed.

Next, the common electrode 127 may be formed by depositing a metal layer (not illustrated) for forming a common electrode at an upper portion of the planarization layer 125 and then selectively patterning the metal layer (not illustrated) through the mask process using the photolithography technique. The common electrode 127 may be formed of a transparent conductive material or an opaque conductive material. For example, the common electrode 127 may be formed of indium tin oxide (ITO), indium zinc oxide (IZO), or another conductive material. Here, the common electrode 127 may be formed on the second glass substrate 210 (see FIG. 5C) disposed to face the first glass substrate 110 instead of being formed on the first glass substrate 110.

Then, the second interlayer insulation film 129 may be formed on upper portions of the planarization layer 125 including the common electrode 127 and the exposed first interlayer insulation film 122 and link lines 124. The first interlayer insulation film 122 may be made of an inorganic insulation material such as SiN or SiOx. In addition, the second interlayer insulation film 129 may be formed of a single-layer structure or a multi-layer structure made of an inorganic insulation material.

Next, by selectively removing the second interlayer insulation film 129 and the first interlayer insulation film 122 there below through the mask process using the photolithography technique, a drain contact hole (not illustrated) configured to expose the drain electrode 118 of the thin film transistor T and an opening (not illustrated) configured to expose the link lines 124 may be formed. Here, a portion of the second interlayer insulation film 129 on the planarization layer 125 located at the upper portion of the etch stopper 123 of the bending area BA may also be removed together. For example, when the second interlayer insulation film 129 is made of an inorganic material, and the second interlayer insulation film 129 made of an inorganic material is present in the bending area BA, cracks occur while the bending area BA is being bent. Therefore, since the cracks may spread toward the display area DA, a portion of the second interlayer insulation film 129 that is formed in the bending area BA may be removed to block the spreading of the cracks toward the display area DA.

Then, the pixel electrode 131 may be formed by depositing a metal layer (not illustrated) for forming a pixel electrode, which is electrically connected to the drain electrode 118 of the thin film transistor T, on an upper portion of the second interlayer insulation film 129 and then selectively patterning the metal layer (not illustrated) through the mask process using the photolithography technique. The pixel electrode 131 may be connected to the drain electrode 118 through the drain contact hole (not illustrated) formed in the first interlayer insulation film 122, the planarization layer 125, and the second interlayer insulation film 129. In addition, during the process of forming the pixel electrode 131, the connection line 132 connected to the COG 120 and the pad part 121 may be formed together on the upper portion of the sub-glass substrate 112 located in the non-display area NDA. Here, the connection line 132 may be connected to the link lines 124, the COG 120, and the pad part 121 by the first interlayer insulation film 122, the planarization layer 125, and the second interlayer insulation film 129 or by the contact hole (not illustrated) formed in the first and second interlayer insulation films 122 and 129.

Next, referring to FIG. 5B, an organic layer (not illustrated) for forming a bump pattern may be formed on the upper portion of the first glass substrate 110 including the second interlayer insulation film 129 and the exposed planarization layer 125. Here, the organic layer (not illustrated) may be formed on entire surfaces of the display area DA and the non-display area NDA of the first glass substrate 110.

Here, the organic layer may be made of an organic material having flexibility or elasticity to prevent or at least reduce an occurrence of cracks caused by stress while being bent. The organic material may include at least one of a silicone-based organic material, urethane, polyimide, and photo acryl. However, the present disclosure is not limited thereto.

Then, by selectively removing the organic insulation layer by the exposure and development process using the photolithography technique, the bump pattern 135 may be formed on the upper portion of the planarization layer 125 on the etch stopper 123 located in the bending area BA.

Accordingly, since the bump pattern 135 is formed on the planarization layer 125 laminated on the upper portion of the etch stopper 123 overlapping the bending area BA, the bump pattern 135 may reinforce the thickness of an organic layer laminated on the etch stopper 123 and thereby prevent or at least reduce an occurrence of cracks in lines, such as the link lines 124, while performing etching on the first glass substrate 110 and the sub-glass substrate 112 in the bending area BA and prevent or at least reduce the occurrence of damage to the etch stopper 123 caused by an external force.

Moreover, when forming the bump pattern 135, the sub-bump pattern 137 may be formed on the second interlayer insulation film 129 located on the upper portion of the thin film transistor T present in the display area DA. Accordingly, the bump pattern 135 and the sub-bump pattern 137 may be formed via the same mask process. Here, as will be described below, the sub-bump pattern 137 may be disposed to overlap and come into contact with the column spacer 221 (see FIG. 5C) disposed on the second glass substrate 210 disposed to face the first glass substrate 110.

Next, the first alignment film (not illustrated) for easily inducing liquid crystal alignment may be formed on upper portions of the bump pattern 135, the sub-bump pattern 137, the pixel electrode 131, and the second interlayer insulation film 129. However, the present disclosure is not limited thereto.

Then, the second glass substrate 210 disposed to correspond to the first glass substrate 110 of the display area DA while having a predetermined cell gap therebetween may be prepared.

Next, the black matrices 213 may be disposed at predetermined intervals on the second glass substrate 210 located in the display area DA.

The black matrices 213 may have a closed loop shape surrounding the display area DA to block light leakage. In addition, the black matrices 213 may also correspond to areas corresponding to the thin film transistor T, the gate line (not illustrated), and the data line (not illustrated) of the first glass substrate 110 to block light leakage. In addition, the black matrices 213 may be provided between the red, green, and blue color filter layers 215, 217, and 219 to prevent color mixture between the color filter layers 215, 217, and 219.

Then, the red (R), green (G), and blue (B) color filter layers 215, 217, and 219 each configured to filter only light of a specific wavelength band may be disposed between the black matrices 213. The color filter layers 215, 217, and 219 may each include an acryl resin and a pigment. The color filter layers 215, 217, and 219 may be classified into red (R), green (G), and blue (B) according to the type of pigment implementing the colors.

Next, the overcoat layer (not illustrated) may be further formed on the black matrices 213 and the color filter layers 215, 217, and 219. The overcoat layer (not illustrated) may be provided to protect the color filter layers 215, 217, and 219 and improve adhesion through surface planarization of the color filter layers 215, 217, and 219 and may be made of an acrylic resin.

Then, the second alignment film (not illustrated) may be formed at the upper portion of the overcoat layer (not illustrated) to easily induce liquid crystal alignment.

Next, the column spacer 221 may be disposed to overlap an area of the thin film transistor T of the first glass substrate 110 disposed to face the second glass substrate 210 at a predetermined gap on an upper portion of the second alignment film (not illustrated). Here, the column spacer 221 may be disposed to come into contact with the upper surface of the above-described sub-bump pattern 137.

Then, the seal line 223 may be disposed in the non-display area NDA of the first glass substrate 110 and the second glass substrate 210. Here, the first and second glass substrates 110 and 210 may be bonded by the seal line 223.

The seal line 223 may be provided on the planarization layer 125 while spaced apart from the first alignment film (not illustrated) and may be disposed to face the planarization layer 125 and the black matrices 213. The seal line 223 may be made of a sealant. For example, the sealant may be a photocurable or thermosetting epoxy resin. However, the present disclosure is not limited thereto. The seal line 223 serves to form a gap for liquid crystal injection and prevent leakage of injected liquid crystals.

Next, by the seal line 223, an LCD device is configured by forming a thermosetting resin of a predetermined pattern on the first glass substrate 110, placing the second glass substrate 210 on the first glass substrate 110, and then pressing and curing the two substrates 110 and 210 to bond the two substrates 110 and 210. However, the present disclosure is not limited thereto.

Then, an area in which a predetermined cell gap is formed between the first glass substrate 110 and the second glass substrate 210 may be filled with the liquid crystal layer 230. The liquid crystal layer 230 may include a liquid crystal having an optical anisotropic characteristic.

The display device 100 according to one embodiment of the present disclosure may display a desired image by driving liquid crystal cells using a data voltage supplied to the pixel electrode 131 and a common voltage supplied to the common electrode 127 to adjust light transmittance of the liquid crystal cells.

Next, after the process of fabricating the LCD device is completed, a process of etching portions of the first glass substrate 110 and the sub-glass substrate 112 located in the bending area BA may be performed to expose the lower portion of the etch stopper 123.

Through such an etching process, the first etching surface 110b and the second etching surface 112b may be formed on the first glass substrate 110 and the sub-glass substrate 112, respectively, that are located below both side surfaces of the etch stopper 123.

Here, in one embodiment, “the first etching surface 110b overlaps the bending area BA” may mean that the first etching surface 110b faces a rear surface of the etch stopper 123 that overlaps the bending area BA. In addition, since the display device has a structure that cannot be bent when the first etching surface 110b is not provided in the bending area BA of the display device, the bending area BA of the display device may be defined as overlapping the first etching surface 110b.

The first glass substrate 110 may include the first upper surface 110a and the first etching surface 110b disposed on one side of the first upper surface 110a and may further include the first lower surface 110c facing the first upper surface 110a.

The first end E1, which is the boundary between the first upper surface 110a and the first etching surface 110b, and the second end E2, which is the boundary between the first etching surface 110b and the first lower surface 110c, may be defined on the first glass substrate 110.

The slope of the first etching surface 110b may be defined by the inclined surface connecting the first end E1 and the second end E2. Although the first etching surface 110b is illustrated as having an inclined tapered surface, the embodiment of the present disclosure is not limited thereto.

Moreover, the sub-glass substrate 112 divided from the first glass substrate 110 due to etching of the first glass substrate 110 may include the second etching surface 112b provided to overlap the bending area BA. Here, in one embodiment, “the second etching surface 112b overlaps the bending area BA” may mean that the second etching surface 112b faces a rear surface of the sub-glass substrate 112 that overlaps the second etching surface 112b. In addition, since the display device 100 has a structure that cannot be bent when the second etching surface 112b is not provided in the bending area BA of the display device 100, the bending area BA of the display device 100 may be defined as overlapping the second etching surface 112b.

The sub-glass substrate 112 may include the second upper surface 112a and the second etching surface 112b disposed on one side of the second upper surface 112a and may further include the second lower surface 112c facing the second upper surface 112a.

The first etching surface 110b of the first glass substrate 110 and the second etching surface 112b of the sub-glass substrate 112 may be referred to as having a reverse-tapered shape or an undercut structure when formed as in shown FIG. 4. Here, as shown in FIG. 5C, the reverse-tapered shape may mean that, when it is assumed that the first end E1 and the third end E3 correspond to an opening pattern for etching, the area between the second end E2 and the fourth end E4 are formed to be larger than the opening pattern.

In the display device according to one embodiment of the present disclosure, since a bump pattern is formed on a planarization film disposed on upper portions of an etch stopper and link lines to reinforce a thickness of an organic material, it is possible to prevent an occurrence of cracks in lines and prevent damage to the etch stopper caused by an external force when etching is performed on a glass substrate present in a bending area.

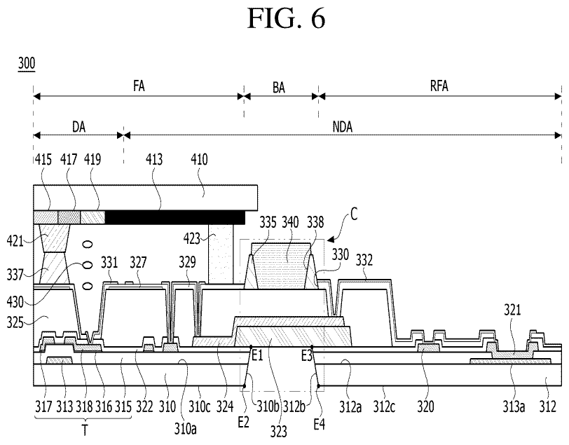

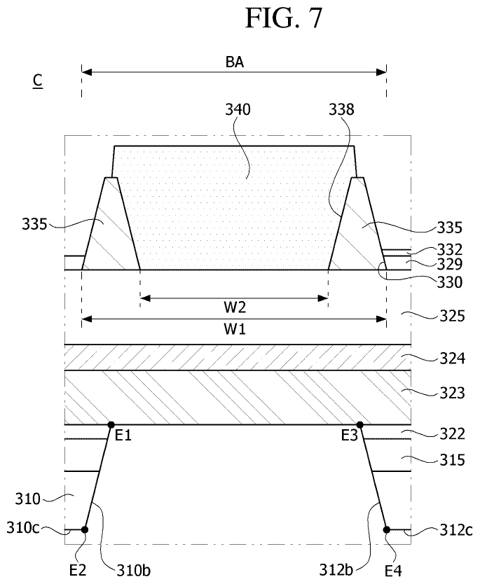

Meanwhile, a display device according to another embodiment of the present disclosure will be described in detail with reference to FIGS. 6 and 7.

Here, the display device according to another embodiment of the present disclosure may include the same components as the display device according to one embodiment of the present disclosure with the exception of a laminated structure of a bump pattern 335 and a reinforcing pattern 340 disposed on a planarization layer 325 laminated on an upper portion of an etch stopper 323 of a bending area BA.

Hereinafter, in the display device according to another embodiment of the present disclosure, the bump patterns 335 and the reinforcing pattern 340 disposed on an upper portion of the planarization layer 325 located in the bending area BA will be mainly described.

FIG. 6 is a cross-sectional view along line I-I′ of FIG. 2 according to another embodiment of the present disclosure. FIG. 7 is an enlarged cross-sectional view of portion C of FIG. 6 according to one embodiment of the present disclosure.

Referring to FIGS. 6 and 7, a display device 300 according to another embodiment of the present disclosure may include a first glass substrate 310 including a display area DA and a non-display area NDA, a second glass substrate 410 disposed to face the first glass substrate 310 at a predetermined cell gap, a liquid crystal layer 430 disposed between the first and second glass substrates 310 and 410, and a sub-glass substrate 312 disposed to be bent at a lower portion of the first glass substrate 310.

Here, a thin film transistor T, a gate line, a data line, and a pixel electrode 331 may be disposed on an upper portion of a first upper surface 310a of the first glass substrate 310.

Moreover, red, green, and blue color filter layers 415, 417, and 419 may be disposed on an upper portion of the second glass substrate 410 that is a color filter array substrate disposed to face the first glass substrate 310, which is a thin film transistor array substrate, at a predetermined gap.

In addition, the liquid crystal layer 430 may be filled between the first glass substrate 310 and the second glass substrate 410 located in the display area DA. Further, a light source part 250 (see FIG. 12) configured to emit light toward an upper portion of the first glass substrate 310 may be disposed between the first glass substrate 310 and the sub-glass substrate 312 disposed to face a lower portion of the first glass substrate 310 through bending of the bending area BA.

The display area DA is an area where an image is displayed and may include a plurality of pixels. The display area DA may be supported by the first upper surface 310a of the first glass substrate 310.

The display area DA may include a plurality of pixels. The plurality of pixels may be disposed in a matrix form, and each of the plurality of pixels may include sub-pixels. The display area DA may have a substantially rectangular shape. In addition, the embodiments of the present disclosure are not limited thereto.

The non-display area NDA is an area surrounding the display area DA, and a device and a circuit line for driving the display area DA may be disposed in the non-display area NDA.

The bending area BA may be defined as an area provided to allow one portion of the display device 300 to be bent. Accordingly, the display device 300 according to one example of the present disclosure may be folded to have a predetermined radius of curvature according to the bending of the bending area BA.

The display device 300 may include various additional elements for generating various signals or driving a plurality of sub-pixels in the display area DA. Additional elements for driving the sub-pixels may include an inverter circuit, a multiplexer, an electrostatic discharge (ESD) circuit, and the like. The display device 300 may also include additional elements associated with functions other than driving sub-pixels.

Referring to FIG. 6, the thin film transistor T including a gate electrode 313, a gate insulation film 315, an active layer 316, a source electrode 317, and a drain electrode 318 may be formed on an upper portion of the first upper surface 310a of the first glass substrate 310 of the display area DA constituting the display device 300 according to another embodiment of the present disclosure.

Moreover, a chip-on-glass (COG) 320 and a flexible printed circuit (FPC) 313a may be formed on an upper portion of a second upper surface 312a of the sub-glass substrate 312 of the non-display area NDA.

In addition, a connection line 332 and a pad part 321 connected to the COG 320 and the FPC 313a may be formed on the upper portion of the second upper surface 312a of the sub-glass substrate 312 located in the non-display area NDA.

A first interlayer insulation film 322 may be formed on entire surfaces of the first upper surface 310a including the thin film transistor T of the first glass substrate 310 and the second upper surface 312a of the sub-glass substrate 312.

Moreover, the etch stopper 323 may be disposed on upper portions of the first glass substrate 310 and the sub-glass substrate 312 located in the bending area BA of the non-display area NDA. The etch stopper 323 may be disposed on the first interlayer insulation film 322 located in the bending area BA.

A link line 324 may be disposed on an upper portion of the first interlayer insulation film 322 across the upper surface and side surfaces of the etch stopper 323.

In addition, in the bending area BA, one portion of a lower surface of the etch stopper 323 may be exposed due to the first glass substrate 310 and the sub-glass substrate 312 being partially removed.

Moreover, the first etching surface 310b and the second etching surface 312b may be disposed on the first glass substrate 310 and the sub-glass substrate 312, respectively, that are located below both side surfaces of the etch stopper 323.

Here, in one embodiment, “the first etching surface 310b overlaps the bending area BA” may mean that the first etching surface 310b faces a rear surface of the etch stopper 323 that overlaps the bending area BA. In addition, since the display device has a structure that cannot be bent when the first etching surface 310b is not provided in the bending area BA of the display device, the bending area BA of the display device may be defined as overlapping the first etching surface 310b.

In addition, the first glass substrate 310 may include the first upper surface 310a and the first etching surface 310b disposed at one side of the first upper surface 310a and may further include a first lower surface 310c facing the first upper surface 310a.

Although the first etching surface 310b is illustrated as having an inclined tapered surface in FIG. 7, the embodiment of the present disclosure is not limited thereto.

The sub-glass substrate 312 may include the second etching surface 312b provided to overlap the bending area BA. Here, in one embodiment, “the second etching surface 312b overlaps the bending area BA” may mean that the second etching surface 312b faces a rear surface of the sub-glass substrate 312 that overlaps the second etching surface 312b. In addition, since the display device 300 has a structure that cannot be bent when the second etching surface 312b is not provided in the bending area BA of the display device 300, the bending area BA of the display device 300 may be defined as overlapping the second etching surface 312b.

The sub-glass substrate 312 may include the second upper surface 312a and the second etching surface 312b disposed at one side of the second upper surface 312a and may further include a second lower surface 312c facing the second upper surface 312a.

The first etching surface 310b of the first glass substrate 310 and the second etching surface 312b of the sub-glass substrate 312 may be referred to as having a reverse-tapered shape or an undercut structure when formed as shown in FIG. 7.

The etch stopper 323 may be disposed to overlap the bending area BA. For example, the etch stopper 323 may be disposed to overlap only the bending area BA.

The etch stopper 323 may be a configuration for preventing or at least reducing damage caused by etching to areas of the display device that overlap the first etching surface 310b and the second etching surface 312b when an etching process necessary to prepare the first glass substrate 310 and the sub-glass substrate 312 is performed. Accordingly, the etch stopper 323 may be disposed to overlap the bending area BA of the display device.

In addition, the etch stopper 323 may include the bending area BA and may overlap the first upper surface 310a of the first glass substrate 310 that extends to one side of the bending area BA and may overlap the second upper surface 312a of the sub-glass substrate 312 that extends to the other side of the bending area BA.

The etch stopper 323 may be used as a layer for protecting configurations located at an upper portion of the etch stopper 323, such as a plurality of link lines 324, in a process of forming the first etching surface 310b of the first glass substrate 310 and the second etching surface 312b of the sub-glass substrate 312. The etch stopper 323 may have a larger size than areas overlapping the first etching surface 310b of the first glass substrate 310 and the second etching surface 312b of the sub-glass substrate 312 or may have a larger size than an area of the bending area BA.

The etch stopper 323 according to another embodiment of the present disclosure may prevent damage to the display device caused by an etchant being used in a glass etching process for forming the first etching surface 310b of the first glass substrate 310 and the second etching surface 312b of the sub-glass substrate 312. The etch stopper 323 may be made of a material having corrosion resistance (or tolerance) to an etchant used in the substrate etching process.

In the display device 300 according to another embodiment of the present disclosure, damage to the display device 300 caused by the glass etching process for forming the first etching surface 310b of the first glass substrate 310 and the second etching surface 312b of the sub-glass substrate 312 may be prevented or at least reduced due to the etch stopper 323.

Moreover, in consideration of a process margin caused by etching in the process of forming the first etching surface 310b of the first glass substrate 310 and the second etching surface 312b of the sub-glass substrate 312, the etch stopper 323 may be formed to also overlap areas extending to one side and the other side of the bending area BA. Specifically, the etch stopper 323 may be formed so that a predetermined area thereof overlaps the first upper surface 310a of the first glass substrate 310 and the second upper surface 312a of the sub-glass substrate 312. When the etch stopper 323 is formed to extend to one side and the other side of the bending area BA, stability with respect to an etching process for forming the first etching surface 310b of the first glass substrate 310 and the second etching surface 312b of the sub-glass substrate 312 may be improved.

Moreover, the planarization layer 325 may be formed at upper portions of the first glass substrate 310 and the sub-glass substrate 312 that include the thin film transistor T of the display area DA and the plurality of link lines 324 of the non-display area NDA.

In addition, a common electrode 327 may be disposed on an upper portion of the planarization layer 325. The common electrode 327 may be formed of a transparent conductive material or an opaque conductive material. A second interlayer insulation film 329 may be formed on the upper portion of the planarization layer 325 that includes the common electrode 327. Here, the second interlayer insulation film 329 may also be formed on the first interlayer insulation film 322 and an exposed portion of the link lines 324.

Moreover, the pixel electrode 331 electrically connected to the drain electrode 318 of the thin film transistor T may be formed on an upper portion of the second interlayer insulation film 329. The pixel electrode 331 may be connected to the drain electrode 318 through a drain contact hole (not illustrated) formed in the first interlayer insulation film 322 and the second interlayer insulation film 329. In addition, the connection line 332 connected to the COG 320 and the pad part 321 may be formed on an upper portion of the sub-glass substrate 312 located in the non-display area NDA. The connection line 332 may be connected to the COG 320 and the pad part 321 through the first interlayer insulation film 322 and the second interlayer insulation film 329 or through a contact hole (not illustrated) formed in the first and second interlayer insulation films 322 and 329.

Moreover, referring to FIGS. 6 and 7, in the second interlayer insulation film 329, a first opening 330, at which a portion of the second interlayer insulation film 329 located in the bending area BA is removed and the planarization layer 325 there below is exposed, may be formed. For example, when the second interlayer insulation film 329 is made of an inorganic material, and the second interlayer insulation film 329 made of an inorganic material is present in the bending area BA, cracks occur while the bending area BA is being bent. Therefore, since the cracks may spread toward the display area DA, a portion of the second interlayer insulation film 329 that is formed in the bending area BA may be removed to block the spreading of the cracks toward the display area DA.

The bump patterns 335 constituting a dam may be disposed at a predetermined interval on both sides of an upper portion of the first opening 330 formed by removing one portion of the second interlayer insulation film 329 located in the bending area BA, that is, an upper portion of the exposed planarization layer 325 on the etch stopper 323. The bump patterns 335 may be made of an organic material. In particular, the bump patterns 335 may be made of an organic material having flexibility or elasticity to prevent or at least reduce an occurrence of cracks caused by stress while being bent. In addition, the bump pattern 335 may be made of an organic material identical to a material of which a column spacer formed on the second glass substrate 410 is formed. However, the present disclosure is not limited thereto.

Here, a second opening 338 may be formed between the bump patterns 335 disposed at a predetermined interval on both sides in the first opening 330. Here, a width W2 of the second opening 338 may be formed to be smaller than a width W1 of the first opening 330.

Moreover, when forming the bump patterns 335, a sub-bump pattern 337 may be disposed on the second interlayer insulation film 329 located on an upper portion of the thin film transistor T located in the display area DA. Here, as will be described below, the sub-bump pattern 337 may be disposed to overlap and come into contact with a column spacer 421 disposed on the second glass substrate 410 which is a color filter array substrate.

In addition, the reinforcing pattern 340 having a predetermined thickness may be disposed in the second opening 338 between the bump patterns 335 located in the bending area BA. Here, the thickness of the reinforcing pattern 340 may be greater than or equal to the thickness of the bump patterns 335. However, the present disclosure is not necessarily limited thereto.

Moreover, as will be described below, an organic material identical to a material forming a seal line 423 or a material different therefrom may be used as a material of the reinforcing pattern 340. The reinforcing pattern 340 may be made of an organic material or made of the same organic layer as the seal line 423. However, the present disclosure is not necessarily limited thereto.

Accordingly, since the bump patterns 335 and the reinforcing pattern 340 are formed on the planarization layer 325 laminated on the upper portion of the etch stopper 323 overlapping the bending area BA, the bump patterns 335 and the reinforcing pattern 340 may reinforce the thickness of an organic layer laminated on the etch stopper 323 and thereby prevent or at least reduce an occurrence of cracks in lines, such as the link lines 324, while performing etching on the first glass substrate 310 and the sub-glass substrate 312 in the bending area BA. Here, the reinforcing pattern 340 may be formed to be higher or lower than the bump patterns 335. The present disclosure is not limited thereto. Since the bump patterns 335 share the same thickness with sub-bump patterns 337 of the display area DA, it is difficult to adjust the thickness. However, since the reinforcing pattern 340 may be independently applied only on the bending area BA, the thickness of the organic layer can be adjusted. In addition, since the greater the thickness of the organic layer of the bending area BA, the more it is difficult to bend the bending area BA, it may be preferable to form the thickness of the reinforcing pattern 340 to be higher than the thickness of the bump patterns 335.

Moreover, since the bump patterns 335 can further reinforce the thickness of the reinforcing pattern 340, which is an organic layer laminated on the etch stopper 323, by preventing the reinforcing pattern 340 from being detached to the left or right, the bump patterns 335 can more effectively prevent the occurrence of damage to the etch stopper 323 caused by an external force.

In addition, a first alignment film (not illustrated) for easily inducing liquid crystal alignment may be formed at an upper portion of the pixel electrode 331.

Meanwhile, black matrices 413 may be disposed at a predetermined interval on the second glass substrate 410 disposed to correspond to the first glass substrate 310 of the display area DA while having a predetermined cell gap therebetween.

The black matrices 413 may have a closed loop shape surrounding the display area DA to block light leakage. Moreover, the black matrix 413 may also correspond to areas corresponding to the thin film transistor T, a gate line (not illustrated), and a data line (not illustrated) of the first glass substrate 310 to block light leakage. In addition, the black matrices 413 may be disposed between the red, green, and blue color filter layers 415, 417, and 419 to prevent color mixture between the color filter layers 415, 417, and 419.

The red (R), green (G), and blue (B) color filter layers 415, 417, and 419 each configured to filter only light of a specific wavelength band may be disposed between the black matrices 413. The color filter layers 415, 417, and 419 may each include an acryl resin and a pigment. The color filter layers 415, 417, and 419 may be classified into red (R), green (G), and blue (B) according to the type of pigment implementing the colors.

Moreover, an overcoat layer (not illustrated) may be further formed on the black matrices 413 and the color filter layers 415, 417, and 419. The overcoat layer (not illustrated) may be provided to protect the color filter layers 415, 417, and 419 and improve adhesion through surface planarization of the color filter layers 415, 417, and 419 and may be made of an acrylic resin.

In addition, a second alignment film (not illustrated) may be formed on an upper portion of the overcoat layer (not illustrated) to easily induce liquid crystal alignment.

The column spacer 421 may be disposed to overlap an area of the thin film transistor T of the first glass substrate 310 disposed to face the second glass substrate 410 at a predetermined gap on an upper portion of the second alignment film (not illustrated). The column spacer 421 may be disposed to overlap and come into contact with an upper surface of the above-described sub-bump pattern 337.

Moreover, the seal line 423 may be disposed in the non-display area NDA of the first glass substrate 310 and the second glass substrate 410. Here, the first and second glass substrates 310 and 410 may be bonded by the seal line 423.

The seal line 423 may be provided on the second interlayer insulation film 329 while spaced apart from the first alignment film (not illustrated) and may be disposed to face the second interlayer insulation film 329 and the black matrices 413. The seal line 423 may be made of a sealant. For example, the sealant may be a photocurable or thermosetting epoxy resin. The seal line 423 serves to form a gap for liquid crystal injection and prevent leakage of injected liquid crystals.

By the formation of the seal line 423, an LCD device is configured by forming a thermosetting resin of a predetermined pattern on the first glass substrate 310, placing the second glass substrate 410 on the first glass substrate 310, and then pressing and curing the two substrates 310 and 410 to bond the two substrates 310 and 410.

An area in which a predetermined cell gap is formed between the first glass substrate 310 and the second glass substrate 410 may be filled with the liquid crystal layer 430. The liquid crystal layer 430 may include a liquid crystal having an optical anisotropic characteristic.

The display device 300 according to another embodiment of the present disclosure may display a desired image by driving liquid crystal cells using a data voltage supplied to the pixel electrode 331 and a common voltage supplied to the common electrode 327 to adjust light transmittance of the liquid crystal cells.

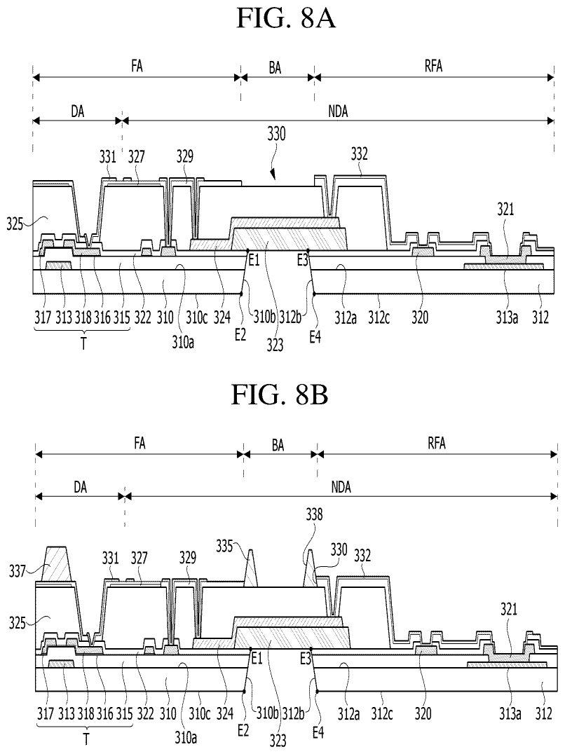

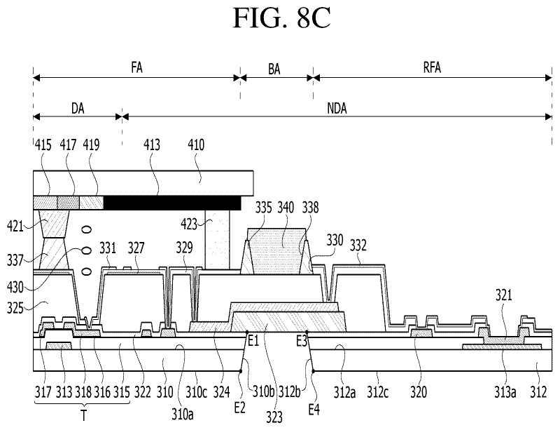

A method of fabricating the display device according to another embodiment of the present disclosure that includes the above configurations will be described with reference to FIGS. 8A to 8C. Here, processes of placing the bump patterns 335 and the reinforcing pattern 340 on the first glass substrate 310 and the sub-glass substrate 312 overlapping the bending area BA will be mainly described.

FIGS. 8A to 8C are cross-sectional views of a process of fabricating the display device according to another embodiment of the present disclosure.

Here, a process of fabricating the display device 300 according to another embodiment of the present disclosure may be the same as the process of fabricating the display device 100 according to one embodiment of the present disclosure with the exception of processes of fabricating the bump patterns 335 and the reinforcing pattern 340 on the upper portion of the planarization layer 325 located in the bending area BA.

Hereinafter, the processes of fabricating the bump patterns 335 and the reinforcing pattern 340 on the upper portion of the planarization layer 325 located in the bending area BA will be mainly described. In addition, a description of a process of forming the thin film transistor T including the gate electrode 313, the gate insulation film 315, the active layer 316, the source electrode 317, and the drain electrode 318 on the first glass substrate 310 will be omitted.

First, referring to FIG. 8A, the first interlayer insulation film 322 may be formed on entire surfaces of the first upper surface 310a including the thin film transistor T of the first glass substrate 310 and the second upper surface 312a of the sub-glass substrate 312. The first interlayer insulation film 322 may have a structure on which a single inorganic insulation layer made of SiN or SiOx is laminated or a structure on which multiple inorganic insulation layers made of SiN or SiOx are laminated. However, the present disclosure is not limited thereto.

Here, the first interlayer insulation film 322 may be disposed on an upper portion of the gate insulation film 315 including the source electrode 317 and the drain electrode 318. The first interlayer insulation film 322 may be made of an inorganic insulation material such as SiN or SiOx. In addition, the first interlayer insulation film 322 may be formed of a single-layer structure or a multi-layer structure made of an inorganic insulation material. The first interlayer insulation film 322 may protect the source electrode 317 and the drain electrode 318 of the thin film transistor T.

Then, an organic insulation layer (not illustrated) for forming the etch stopper 323 may be formed on the first interlayer insulation film 322 present on the first glass substrate 310 located in the bending area BA of the non-display area NDA. The organic insulation layer may include at least one of a silicone-based organic material, urethane, polyimide, and photo acryl. However, the present disclosure is not limited thereto.

Moreover, the organic insulation layer may be made of a material that has resistance to a glass etchant. For example, an etchant including nitric acid (HNO3) or hydrofluoric acid (HF) may be used as an etchant for glass etching in a wet etching process. The etch stopper 323 may be made of one of a metal and an organic material instead of being made of the organic insulation layer. The etch stopper 323 may include at least one of chromium (Cr), aluminum (Al), platinum (Pt), gold (Au), and nickel (Ni).

Next, through an exposure and development process using a photolithography technique, the organic insulation layer (not illustrated) may be selectively removed to remain only in the bending area BA, thereby forming the etch stopper 323. Here, the etch stopper 323 may be disposed to overlap the bending area BA. For example, the etch stopper 323 may be disposed to overlap only the bending area BA.

The etch stopper 323 may be a configuration for preventing damage caused by etching to areas of the display device that overlap the first etching surface 310b and the second etching surface 312b when an etching process necessary to distinguish the first glass substrate 310 and the sub-glass substrate 312 is performed. Accordingly, the etch stopper 323 may be disposed to overlap the bending area BA of the display device.

Here, the etch stopper 323 may include the bending area BA and may overlap the first upper surface 310a of the first glass substrate 310 that extends to one side of the bending area BA and may overlap the second upper surface 312a of the sub-glass substrate 312 that extends to the other side of the bending area BA.

Moreover, the etch stopper 323 may be used as a layer for protecting configurations located at the upper portion of the etch stopper 323, such as a plurality of link lines 324, in a process of forming the first etching surface 310b of the first glass substrate 310 and the second etching surface 312b of the sub-glass substrate 312. The etch stopper 323 may have a larger size than areas overlapping the first etching surface 310b of the first glass substrate 310 and the second etching surface 312b of the sub-glass substrate 312 or may have a larger size than an area of the bending area BA.

In addition, the etch stopper 323 may prevent or at least reduce damage to the display device caused by an etchant being used in a glass etching process for forming the first etching surface 310b of the first glass substrate 310 and the second etching surface 312b of the sub-glass substrate 312. The etch stopper 323 may be made of a material having corrosion resistance (or tolerance) to an etchant used in the glass etching process.

Moreover, the etch stopper 323 may be formed by spraying a material at a set position mechanically using a slit coater, an inkjet, or a dispenser or may be formed via a patterning process using a mask according to the photolithography technique.

In addition, in consideration of a process margin caused by etching in the process of forming the first etching surface 310b of the first glass substrate 310 and the second etching surface 312b of the sub-glass substrate 312, the etch stopper 323 may be formed to also overlap areas extending to one side and the other side of the bending area BA. Specifically, the etch stopper 323 may be formed so that a predetermined area thereof overlaps the first upper surface 310a of the first glass substrate 310 and the second upper surface 312a of the sub-glass substrate 312. Here, when the etch stopper 323 is formed to extend to one side and the other side of the bending area BA, stability with respect to an etching process for forming the first etching surface 310b of the first glass substrate 310 and the second etching surface 312b of the sub-glass substrate 312 may be improved.

Next, the plurality of link lines 324 that may be connected to a plurality of pixel electrodes 331 may be disposed on the upper portion of the first interlayer insulation film 322 across the upper surface and side surfaces of the etch stopper 323.

Then, the planarization layer 325 may be formed on upper portions of the first glass substrate 310 and the sub-glass substrate 312 that include the thin film transistor T of the display area DA and the plurality of link lines 324 of the non-display area NDA.

Here, the planarization layer 325 is a layer for planarizing the upper portion of the first glass substrate 310 and may be formed of an organic insulation material to cover a step difference on the upper portion of the first glass substrate 310. For example, the planarization layer 325 may be made of one or more of polyacrylate resin, epoxy resin, phenolic resin, polyamide resin, polyimide resin, unsaturated polyester resin, polyphenylene resin, polyphenylene sulfide resin, and benzocyclobutene, but is not limited thereto. The planarization layer 325 may be made of a single layer, a double layer, or multiple layers. The planarization layer 325 may be formed with a thickness ranging from 2 μm to 5 μm to sufficiently cover the step difference on the first glass substrate 310.

Then, by selectively patterning the planarization layer 325 through a mask process using the photolithography technique, the first interlayer insulation film 322 and the link lines 324 at the upper portion of the drain electrode 318 of the thin film transistor T may be partially exposed.

Next, the common electrode 327 may be formed by depositing a metal layer (not illustrated) for forming a common electrode on an upper portion of the planarization layer 325 and then selectively patterning the metal layer (not illustrated) through the mask process using the photolithography technique. The common electrode 327 may be formed of a transparent conductive material or an opaque conductive material. For example, the common electrode 327 may be formed of indium tin oxide (ITO), indium zinc oxide (IZO), or another conductive material. Here, the common electrode 327 may be formed on the second glass substrate 410 (see FIG. 8C) disposed to face the first glass substrate 310 instead of being formed on the first glass substrate 310.

Then, the second interlayer insulation film 329 may be formed on the upper portion of the planarization layer 325 including the common electrode 327. Here, the second interlayer insulation film 329 may also be formed at exposed portions of the first interlayer insulation film 322 and etch stopper 323. For example, the first interlayer insulation film 322 may be made of an inorganic insulation material such as SiN or SiOx. In addition, the second interlayer insulation film 329 may be formed of a single-layer structure or a multi-layer structure made of an inorganic insulation material.

Next, the pixel electrode 331 may be formed by depositing a metal layer (not illustrated) for forming a pixel electrode, which is electrically connected to the drain electrode 318 of the thin film transistor T, on an upper portion of the second interlayer insulation film 329 and then selectively patterning the metal layer (not illustrated) through the mask process using the photolithography technique. The pixel electrode 331 may be connected to the drain electrode 318 through the drain contact hole (not illustrated) formed in the first interlayer insulation film 322 and the second interlayer insulation film 329. In addition, during the process of forming the pixel electrode 331, the connection line 332 connected to the COG 320 and the pad part 321 may be formed together on the upper portion of the sub-glass substrate 312 located in the non-display area NDA. Here, the connection line 332 may be connected to the link lines 324, the COG 320, and the pad part 321 through the first interlayer insulation film 322 and the second interlayer insulation film 329 or through the contact hole (not illustrated) formed in the planarization layer 325 and the second interlayer insulation film 329.

Then, the first opening 330 at which a portion of the second interlayer insulation film 329 located in the bending area BA is selectively removed and the planarization layer 325 is exposed may be formed. For example, when the second interlayer insulation film 329 is made of an inorganic material, and the second interlayer insulation film 329 made of an inorganic material is present in the bending area BA, cracks occur while the bending area BA is being bent. Therefore, since the cracks may spread toward the display area DA, a portion of the second interlayer insulation film 329 that is formed in the bending area BA may be removed to block the spreading of the cracks toward the display area DA.

Next, referring to FIG. 8B, an organic layer (not illustrated) for forming bump patterns that serve as a dam may be formed on the upper portion of the first glass substrate 310 including the exposed planarization layer 325. Here, the organic layer (not illustrated) may be formed on entire surfaces of the display area DA and the non-display area NDA of the first glass substrate 310.

The organic layer may be made of an organic material having flexibility or elasticity to prevent an occurrence of cracks caused by stress while being bent. In addition, the organic layer may include at least one of a silicone-based organic material, urethane, polyimide, and photo acryl. However, the present disclosure is not limited thereto.

Moreover, the organic layer may be made of an organic material identical to a material of which a column spacer formed on the second glass substrate 410 (see FIG. 8C) is formed.

Then, by selectively patterning the organic layer by an exposure and development process using the photolithography technique, the bump patterns 335 (dam patterns) may be formed on both sides with the second opening 338 disposed therebetween on the upper portion of the planarization layer 325 on the etch stopper 323 located in the bending area BA.

Moreover, in a process of forming the bump patterns 335, the sub-bump pattern 337 may be formed together on the upper portion of the second interlayer insulation film 329 located on the upper portion of the thin film transistor T present in the display area DA. Here, the sub-bump pattern 337 may be disposed to overlap and come into contact with the column spacer 421 disposed on the second glass substrate 410 disposed to face the first glass substrate 310.

Next, the first alignment film (not illustrated) for easily inducing liquid crystal alignment may be formed on upper portions of the bump patterns 335, the sub-bump pattern 337, the pixel electrode 331, and the second interlayer insulation film 329. However, the present disclosure is not limited thereto.

Then, the second glass substrate 410 disposed to correspond to the first glass substrate 310 of the display area DA while having a predetermined cell gap therebetween may be prepared.

Next, the black matrices 413 may be disposed at a predetermined interval on the second glass substrate 410 located in the display area DA.

The black matrices 413 may have a closed loop shape surrounding the display area DA to block light leakage. In addition, the black matrices 413 may also correspond to areas corresponding to the thin film transistor T, the gate line (not illustrated), and the data line (not illustrated) of the first glass substrate 310 to block light leakage. Moreover, the black matrices 413 may be provided between the red, green, and blue color filter layers 415, 417, and 419 to prevent color mixture between the color filter layers 415, 417, and 419.

Then, the red (R), green (G), and blue (B) color filter layers 415, 417, and 419 each configured to filter only light of a specific wavelength band may be disposed between the black matrices 413. The color filter layers 415, 417, and 419 may each include an acryl resin and a pigment. The color filter layers 415, 417, and 419 may be classified into red (R), green (G), and blue (B) according to the type of pigment implementing the color.

Next, the overcoat layer (not illustrated) may be further formed on the black matrices 413 and the color filter layers 415, 417, and 419. The overcoat layer (not illustrated) may be provided to protect the color filter layers 415, 417, and 419 and improve adhesion through surface planarization of the color filter layers 415, 417, and 419 and may be made of an acrylic resin.

Then, the second alignment film (not illustrated) may be formed on the upper portion of the overcoat layer (not illustrated) to easily induce liquid crystal alignment.

Next, the column spacer 421 may be disposed to overlap an area of the thin film transistor T of the first glass substrate 310 disposed to face the second glass substrate 410 at a predetermined gap on an upper portion of the second alignment film (not illustrated). Here, the column spacer 421 may be disposed to come into contact with the upper surface of the above-described sub-bump pattern 337.

Then, the seal line 423 may be disposed in the non-display area NDA of the first glass substrate 310 and the second glass substrate 410. Here, the first and second glass substrates 310 and 410 may be bonded by the seal line 423.

The seal line 423 may be provided on the planarization layer 325 while spaced apart from the first alignment film (not illustrated) and may be disposed to face the planarization layer 325 and the black matrices 413. The seal line 423 may be made of a sealant. For example, the sealant may be a photocurable or thermosetting epoxy resin. The seal line 423 serves to form a gap for liquid crystal injection and prevent leakage of injected liquid crystals.

Next, by the seal line 423, an LCD device is configured by forming a thermosetting resin of a predetermined pattern on the first glass substrate 310, placing the second glass substrate 410 on the first glass substrate 310, and then pressing and curing the two substrates 310 and 410 to bond the two substrates 310 and 410. However, the present disclosure is not limited thereto.

Moreover, when forming the seal line 423, the reinforcing pattern 340 may also be formed together in the second opening 338 between the bump patterns 335 disposed on the planarization layer 325. Here, the thickness of the reinforcing pattern 340 may be greater than or equal to the height of the bump patterns 335 or may be less than the height of the bump patterns 335. However, the present disclosure is not necessarily limited thereto.

Accordingly, since the reinforcing pattern 340 is formed on the planarization layer 325 laminated on the upper portion of the etch stopper 323 overlapping the bending area BA, the reinforcing pattern 340 may reinforce the thickness of the organic layer laminated on the etch stopper 323 and thereby prevent an occurrence of cracks in lines, such as, the link lines 324, while performing etching on the first glass substrate 310 and the sub-glass substrate 312 in the bending area BA.

Here, since the bump patterns 335 share the same thickness with the sub-bump patterns 337 of the display area DA, it is difficult to adjust the thickness. However, since the reinforcing pattern 340 may be independently applied only on the bending area BA, the thickness of the organic layer can be adjusted. In addition, since the greater the thickness of the organic layer of the bending area BA, the more it is difficult to bend the bending area BA, it may be preferable to form the thickness of the reinforcing pattern 340 to be higher than the thickness of the bump patterns 335.

Then, an area in which a predetermined cell gap is formed between the first glass substrate 310 and the second glass substrate 410 may be filled with the liquid crystal layer 430. The liquid crystal layer 430 may include liquid crystals having an optical anisotropic characteristic.

The display device 300 according to another embodiment of the present disclosure may display a desired image by driving liquid crystal cells using a data voltage supplied to the pixel electrode 331 and a common voltage supplied to the common electrode 327 to adjust light transmittance of the liquid crystal cells.

Next, after the process of fabricating the LCD device is completed, a process of etching portions of the first glass substrate 310 and the sub-glass substrate 312 located in the bending area BA may be performed to expose a lower portion of the etch stopper 323.

Through such an etching process, the first etching surface 310b and the second etching surface 312b may be formed on the first glass substrate 310 and the sub-glass substrate 312, respectively, that are located below both side surfaces of the etch stopper 323.

Here, in one embodiment, “the first etching surface 310b overlaps the bending area BA” may mean that the first etching surface 310b faces a rear surface of the etch stopper 323 that overlaps the bending area BA. In addition, since the display device has a structure that cannot be bent when the first etching surface 310b is not provided in the bending area BA of the display device, the bending area BA of the display device may be defined as overlapping the first etching surface 310b.

Moreover, the first glass substrate 310 may include the first upper surface 310a and the first etching surface 310b disposed on one side of the first upper surface 310a and may further include the first lower surface 310c facing the first upper surface 310a.

Although the first etching surface 310b is illustrated as having an inclined tapered surface, the embodiment of the present disclosure is not limited thereto.

In addition, the sub-glass substrate 312 divided from the first glass substrate 310 due to etching of the first glass substrate 310 may include the second etching surface 312b provided to overlap the bending area BA. Here, in one embodiment, “the second etching surface 312b overlaps the bending area BA” may mean that the second etching surface 312b faces a rear surface of the sub-glass substrate 312 that overlaps the second etching surface 312b. Moreover, since the display device 300 has a structure that cannot be bent when the second etching surface 312b is not provided in the bending area BA of the display device 300, the bending area BA of the display device 300 may be defined as overlapping the second etching surface 312b.

In addition, the sub-glass substrate 312 may include the second upper surface 312a and the second etching surface 312b disposed on one side of the second upper surface 312a and may further include the second lower surface 312c facing the second upper surface 312a.

The first etching surface 310b of the first glass substrate 310 and the second etching surface 312b of the sub-glass substrate 312 may be referred to as having a reverse-tapered shape or an undercut structure when formed as shown in FIG. 7.

In this way, in the display device according to another embodiment of the present disclosure, since dam patterns are formed on a planarization film disposed on upper portions of an etch stopper and a link line to further reinforce a thickness of an organic material, it is possible to prevent or at least reduce an occurrence of cracks in lines and prevent damage to the etch stopper caused by an external force when etching is performed on a glass substrate present in a bending area.

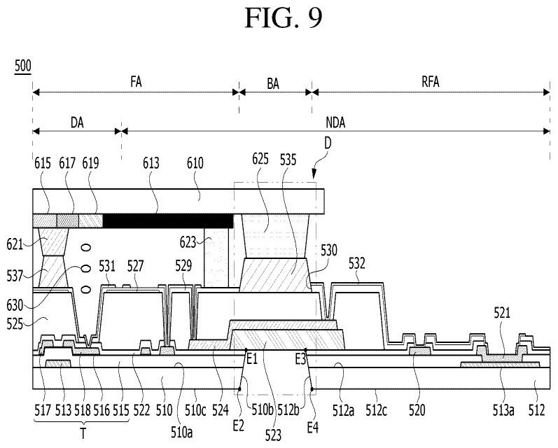

Meanwhile, a display device according to still another embodiment of the present disclosure will be described in detail with reference to FIGS. 9 to 11.

Here, a display device 500 according to still another embodiment of the present disclosure may include the same components as the display device 100 according to one embodiment of the present disclosure with the exception of structures of a bump pattern 535 disposed on a first glass substrate 510 located in a bending area BA and a support pattern 625 additionally disposed on an upper portion of a second glass substrate 610 overlapping the bump pattern 535.

Hereinafter, in the display device according to still another embodiment of the present disclosure, the bump pattern 535 disposed on an upper portion of a planarization layer 525 located in the bending area BA and the support pattern 625 disposed on the upper portion of the second glass substrate 610 to overlap and come into contact with the bump pattern 535 will be mainly described.

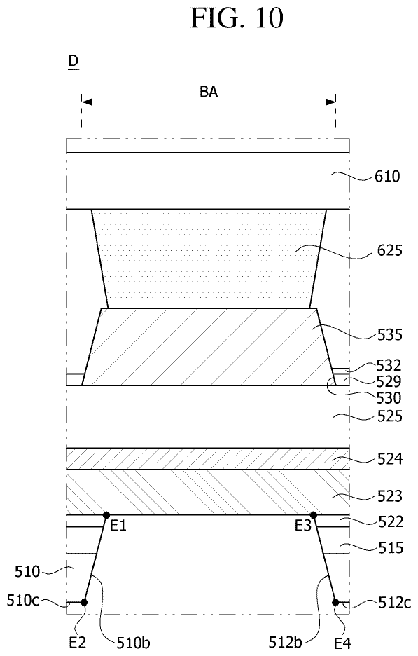

FIG. 9 is a cross-sectional view along line I-I′ of FIG. 2 according to still another embodiment of the present disclosure. FIG. 10 is an enlarged cross-sectional view of portion D of FIG. 9 according to one embodiment.

A thin film transistor T, a gate line, a data line, and a pixel electrode 531 may be disposed on an upper portion of a first upper surface 510a of the first glass substrate 510.

Moreover, red, green, and blue color filter layers 615, 617, and 619 may be disposed on the upper portion of the second glass substrate 610 that is a color filter array substrate disposed to face the first glass substrate 510, which is a thin film transistor array substrate, at a predetermined gap.

In addition, a liquid crystal layer 630 may be filled between the first glass substrate 510 and the second glass substrate 610 located in the display area DA. Moreover, a light source part 250 (see FIG. 12) configured to emit light toward an upper portion of the first glass substrate 510 may be disposed between the first glass substrate 510 and a sub-glass substrate 512 disposed to face a lower portion of the first glass substrate 510 through bending of the bending area BA.

The display area DA is an area where an image is displayed and may include a plurality of pixels. The display area DA may be supported by the first upper surface 510a of the first glass substrate 510.

The display area DA may include a plurality of pixels. The plurality of pixels may be disposed in a matrix form, and each of the plurality of pixels may include sub-pixels. The display area DA may have a substantially rectangular shape. In addition, the embodiments of the present disclosure are not limited thereto.

The non-display area NDA is an area surrounding the display area DA, and a device and a circuit line for driving the display area DA may be disposed in the non-display area NDA.

The bending area BA may be defined as an area provided to allow one portion of the display device 500 to be bent. Accordingly, the display device 500 according to still another embodiment of the present disclosure may be folded to have a predetermined radius of curvature according to the bending of the bending area BA.

Referring to FIG. 9, the thin film transistor T including a gate electrode 513, a gate insulation film 515, an active layer 516, a source electrode 517, and a drain electrode 518 may be formed on an upper portion of the first upper surface 510a of the first glass substrate 510 of the display area DA constituting the display device 500 according to still another embodiment of the present disclosure.

Moreover, a chip-on-glass (COG) 520 and a flexible printed circuit (FPC) 513a may be formed on an upper portion of a second upper surface 512a of the sub-glass substrate 512 of the non-display area NDA.

In addition, a pad part 521 connected to the COG 520 and the FPC 513a may be formed on the upper portion of the second upper surface 512a of the sub-glass substrate 512 located in the non-display area NDA.

A first interlayer insulation film 522 may be formed on entire surfaces of the first upper surface 510a including the thin film transistor T of the first glass substrate 510 and the second upper surface 512a of the sub-glass substrate 512.

Moreover, an etch stopper 523 may be disposed on upper portions of the first glass substrate 510 and the sub-glass substrate 512 located in the bending area BA of the non-display area NDA. The etch stopper 523 may be disposed on the first interlayer insulation film 522 laminated on the gate insulation film 515 located in the bending area BA.

In addition, a plurality of link lines 524 may be disposed on an upper portion of the first interlayer insulation film 522 across the upper surface and side surfaces of the etch stopper 523.

Moreover, one portion of a lower surface of the etch stopper 523 may be exposed due to the first glass substrate 510 and the sub-glass substrate 512, which are located in the bending area BA, being partially removed.

In addition, a first etching surface 510b and a second etching surface 512b may be disposed on the first glass substrate 510 and the sub-glass substrate 512, respectively, that are located below both side surfaces of the etch stopper 523.

Moreover, the first glass substrate 510 may include the first upper surface 510a and the first etching surface 510b disposed on one side of the first upper surface 510a and may further include a first lower surface 510c facing the first upper surface 510a.

Although the first etching surface 510b is illustrated as having an inclined tapered surface in FIG. 10, the embodiment of the present disclosure is not limited thereto.

The sub-glass substrate 512 may include the second etching surface 512b provided to overlap the bending area BA. Here, “the second etching surface 512b overlaps the bending area BA” may mean that the second etching surface 512b faces a rear surface of the sub-glass substrate 512 that overlaps the second etching surface 512b.

The sub-glass substrate 512 may include the second upper surface 512a and the second etching surface 512b disposed on one side of the second upper surface 512a and may further include a second lower surface 512c facing the second upper surface 512a.

In addition, the etch stopper 523 may include the bending area BA and may overlap the first upper surface 510a of the first glass substrate 510 that extends to one side of the bending area BA and may overlap the second upper surface 512a of the sub-glass substrate 512 that extends to the other side of the bending area BA.

In this way, in the display device 500 according to still another embodiment of the present disclosure, damage to the display device 500 caused by performing the glass etching process for forming the first etching surface 510b of the first glass substrate 510 and the second etching surface 512b of the sub-glass substrate 512 may be prevented due to the etch stopper 523.

Moreover, in consideration of a process margin caused by etching in the process of forming the first etching surface 510b of the first glass substrate 510 and the second etching surface 512b of the sub-glass substrate 512, the etch stopper 523 may be formed to also overlap areas extending to one side and the other side of the bending area BA.

In addition, the planarization layer 525 may be formed on upper portions of the first glass substrate 510 and the sub-glass substrate 512 that include the thin film transistor T of the display area DA and the plurality of link lines 524 of the non-display area NDA.

Moreover, a common electrode 527 may be disposed on an upper portion of the planarization layer 525. In addition, a second interlayer insulation film 529 may be formed on the upper portion of the planarization layer 525 that includes the common electrode 527.

In addition, the pixel electrode 531 electrically connected to the drain electrode 518 of the thin film transistor T may be formed on an upper portion of the second interlayer insulation film 529. The pixel electrode 531 may be connected to the drain electrode 518 through a drain contact hole (not illustrated) formed in the first interlayer insulation film 522, the planarization layer 525, and the second interlayer insulation film 529. Moreover, the connection line 532 connected to the COG 520 and the pad part 521 may be formed on an upper portion of the sub-glass substrate 512 located in the non-display area NDA. The connection line 532 may be connected to the COG 520 and the pad part 521 through the first interlayer insulation film 522, the planarization layer 525, and the second interlayer insulation film 529 or through a contact hole (not illustrated) formed in the first and second interlayer insulation films 522 and 529.

In addition, in the second interlayer insulation film 529, an opening 530 at which a portion of the second interlayer insulation film 529 located in the bending area BA is removed and the planarization layer 525 there below is exposed may be formed.

For example, when the second interlayer insulation film 529 is made of an inorganic material, and the second interlayer insulation film 529 made of an inorganic material is present in the bending area BA, cracks occur while the bending area BA is being bent. Therefore, since the cracks may spread toward the display area DA, a portion of the second interlayer insulation film 529 that is formed in the bending area BA may be removed to block the spreading of the cracks toward the display area DA.

Meanwhile, referring to FIGS. 9 and 10, the bump pattern 535 may be disposed on the planarization layer 525 below the opening 530 of the second interlayer insulation film 529 located in the bending area BA. The bump pattern 535 may be made of an organic material. However, the present disclosure is not limited thereto. Moreover, the bump pattern 535 may be made of an organic material having flexibility or elasticity to prevent or at least reduce an occurrence of cracks due to stress during bending. In addition, the bump pattern 535 may be made of an organic material identical to a material of which a column spacer formed on the second glass substrate 610 is formed. However, the present disclosure is not limited thereto.

Moreover, when forming the bump pattern 535, a sub-bump pattern 537 may be disposed on an upper portion of the thin film transistor T located in the display area DA. Here, as will be described below, the sub-bump pattern 537 may be disposed to overlap and come into contact with a column spacer 621 disposed on the second glass substrate 610, which is a color filter array substrate.

In addition, a first alignment film (not illustrated) for easily inducing liquid crystal alignment may be formed on an upper portion of the pixel electrode 531.

Meanwhile, black matrices 613 may be disposed at a predetermined interval on the second glass substrate 610 disposed to correspond to the first glass substrate 510 of the display area DA while having a predetermined cell gap therebetween.

The black matrices 613 may have a closed loop shape surrounding the display area DA to block light leakage. In addition, the black matrices 613 may also correspond to areas corresponding to the thin film transistor T, a gate line (not illustrated), and a data line (not illustrated) of the first glass substrate 510 to block light leakage. Moreover, the black matrices 613 may be disposed between the red, green, and blue color filter layers 615, 617, and 619 to prevent color mixture between the color filter layers 615, 617, and 619.

In addition, an overcoat layer (not illustrated) may be further formed on the black matrices 613 and the color filter layers 615, 617, and 619. The overcoat layer (not illustrated) may be provided to protect the color filter layers 615, 617, and 619 and improve adhesion through surface planarization of the color filter layers 615, 617, and 619 and may be made of an acrylic resin.

Moreover, a second alignment film (not illustrated) may be formed on an upper portion of the overcoat layer (not illustrated) to easily induce liquid crystal alignment.

In addition, the column spacer 621 may be disposed to overlap an area of the thin film transistor T of the first glass substrate 510 disposed to face the second glass substrate 610 at a predetermined gap on an upper portion of the second alignment film (not illustrated). The column spacer 621 may be disposed to overlap and come into contact with an upper surface of the above-described sub-bump pattern 537.

Moreover, the support pattern 625 configured to prevent or at least reduce an occurrence of collapse of the bump pattern 535 caused by etching of the bending area BA may be formed on the upper portion of the second glass substrate 610 located in the non-display area NDA. The support pattern 625 may be formed of an organic material or formed of the same material as the black matrix. However, the present disclosure is not limited thereto.

In addition, a seal line 623 may be disposed in the non-display area NDA of the first glass substrate 510 and the second glass substrate 610. Here, the first and second glass substrates 510 and 610 may be bonded by the seal line 623.

When bonding the first and second glass substrates 510 and 610, the support pattern 625 may be disposed to overlap and come into contact with an upper surface of the bump pattern 535.

The seal line 623 may be disposed on the second interlayer insulation film 529 while spaced apart from the first alignment film (not illustrated) and may be disposed to face the planarization layer 525 and the black matrices 613. The seal line 623 may be made of a sealant. For example, the sealant may be a photocurable or thermosetting epoxy resin. The seal line 623 serves to form a gap for liquid crystal injection and prevent leakage of injected liquid crystals.

By the seal line 623, an LCD device is configured by forming a thermosetting resin of a predetermined pattern on the first glass substrate 510, placing the second glass substrate 610 on the first glass substrate 510, and then pressing and curing the two substrates 510 and 610 to bond the two substrates 510 and 610.

Moreover, an area in which a predetermined cell gap is formed between the first glass substrate 510 and the second glass substrate 610 may be filled with the liquid crystal layer 630. The liquid crystal layer 630 may include liquid crystals having an optical anisotropic characteristic.

The display device 500 according to still another embodiment of the present disclosure may display a desired image by driving liquid crystal cells using a data voltage supplied to the pixel electrode 531 and a common voltage supplied to the common electrode 527 to adjust light transmittance of the liquid crystal cells.

Accordingly, since the bump pattern 535 of the first glass substrate 510 and the support pattern 625 of the second glass substrate 610 are disposed to overlap an upper portion of the etch stopper 523 that overlaps the bending area BA, the thickness of the organic layer laminated on the etch stopper 523 may be further reinforced.

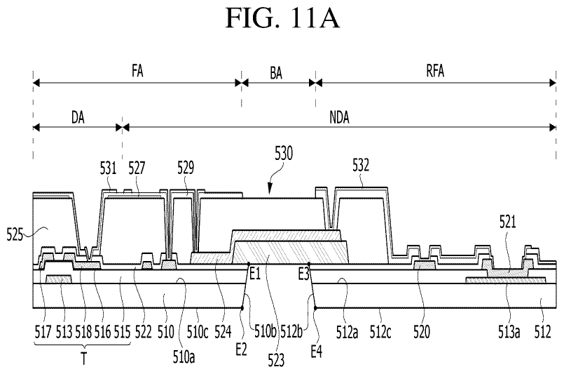

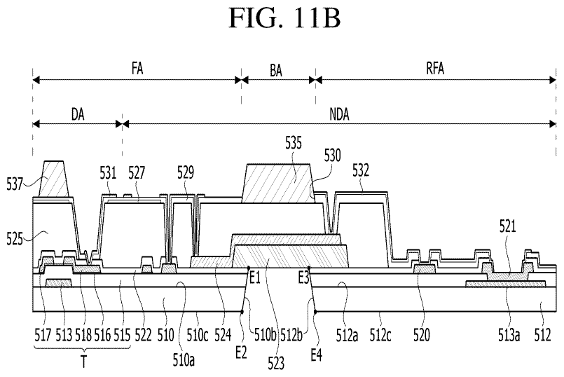

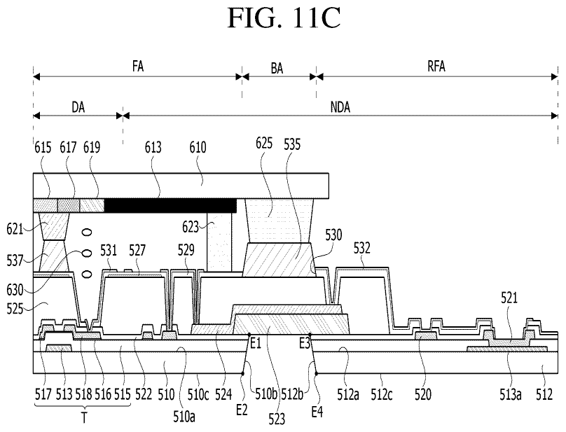

A method of fabricating the display device according to still another embodiment of the present disclosure that includes the above configurations will be described with reference to FIGS. 11A to 11C.

FIGS. 11A to 11C are cross-sectional views of a process of fabricating the display device according to still another embodiment of the present disclosure.

Here, a process of fabricating the display device 500 according to still another embodiment of the present disclosure may be the same as the process of fabricating the display device 100 according to one embodiment of the present disclosure shown in FIGS. 5A to 5C with the exception of a process of placing the support pattern 625 on the second glass substrate 610 located in the bending area BA.

Here, the process of placing the support pattern 625 on the second glass substrate 610 overlapping the bending area BA will be mainly described.

Moreover, a description of a process of forming the thin film transistor T including the gate electrode 513, the gate insulation film 515, the active layer 516, the source electrode 517, and the drain electrode 518 on the first glass substrate 510 will be omitted. In addition, the description of processes of forming the first and second interlayer insulation films 522 and 529, the planarization layer 525, and the pixel electrode 531 will also be omitted.

First, referring to FIG. 11A, after the processes of fabricating the thin film transistor T and the first interlayer insulation film 522 are completed, an organic insulation layer (not illustrated) for forming the etch stopper 523 may be formed on the first interlayer insulation film 522 present on the first glass substrate 510 located in the bending area BA of the non-display area NDA. The organic insulation layer may include at least one of a silicone-based organic material, urethane, polyimide, and photo acryl. However, the present disclosure is not limited thereto.

Moreover, the organic insulation layer may be made of a material that has resistance to a glass etchant. For example, an etchant including nitric acid (HNO3) or hydrofluoric acid (HF) may be used as an etchant for glass etching in a wet etching process. The etch stopper 523 may be made of one of a metal and an organic material instead of being made of the organic insulation layer. The etch stopper 523 may include at least one of chromium (Cr), aluminum (Al), platinum (Pt), gold (Au), and nickel (Ni).

Next, through an exposure and development process using a photolithography technique, the organic insulation layer (not illustrated) may be selectively removed to remain only in the bending area BA, thereby forming the etch stopper 523. Here, the etch stopper 523 may be disposed to overlap the bending area BA. For example, the etch stopper 523 may be disposed to overlap only the bending area BA.

The etch stopper 523 may be a configuration for preventing or at least reducing damage caused by etching to areas of the display device that overlap the first etching surface 510b and the second etching surface 512b when an etching process necessary to distinguish the first glass substrate 510 and the sub-glass substrate 512 is performed. Accordingly, the etch stopper 523 may be disposed to overlap the bending area BA of the display device.

Here, the etch stopper 523 may include the bending area BA and may overlap the first upper surface 510a of the first glass substrate 510 that extends to one side of the bending area BA and may overlap the second upper surface 512a of the sub-glass substrate 512 that extends to the other side of the bending area BA.

Moreover, the etch stopper 523 may be used as a layer for protecting configurations located at the upper portion of the etch stopper 523, such as the plurality of link lines 524, in a process of forming the first etching surface 510b of the first glass substrate 510 and the second etching surface 512b of the sub-glass substrate 512. The etch stopper 523 may have a larger size than areas overlapping the first etching surface 510b of the first glass substrate 510 and the second etching surface 512b of the sub-glass substrate 512 or may have a larger size than an area of the bending area BA.

In addition, the etch stopper 523 may prevent damage to the display device caused by an etchant being used in a glass etching process for forming the first etching surface 510b of the first glass substrate 510 and the second etching surface 512b of the sub-glass substrate 512. The etch stopper 523 may be made of a material having corrosion resistance (or tolerance) to an etchant used in the glass etching process.

Moreover, the etch stopper 523 may be formed by spraying a material at a set position mechanically using a slit coater, an inkjet, or a dispenser or may be formed by a patterning process using a mask according to a photolithography technique.

In addition, in consideration of a process margin caused by etching in the process of forming the first etching surface 510b of the first glass substrate 510 and the second etching surface 512b of the sub-glass substrate 512, the etch stopper 523 may be formed to also overlap areas extending to one side and the other side of the bending area BA. Specifically, the etch stopper 523 may be formed so that a predetermined area thereof overlaps the first upper surface 510a of the first glass substrate 510 and the second upper surface 512a of the sub-glass substrate 512.

Next, the plurality of link lines 524 that may be connected to a plurality of pixel electrodes 531 may be disposed on the upper portion of the first interlayer insulation film 522 across the upper surface and side surfaces of the etch stopper 523.

Then, the planarization layer 525 may be formed on upper portions of the first glass substrate 510 and the sub-glass substrate 512 that include the thin film transistor T of the display area DA and the plurality of link lines 524 of the non-display area NDA. Here, the planarization layer 525 is a layer for planarizing the upper portion of the first glass substrate 510 and may be formed of an organic insulation material to cover a step difference on an upper portion of the first glass substrate 510.

Then, by selectively patterning the planarization layer 525 through a mask process using a photolithography technique, the first interlayer insulation film 522 and the link lines 524 on the upper portion of the drain electrode 518 of the thin film transistor T may be partially exposed.

Next, the common electrode 527 may be formed by depositing a metal layer (not illustrated) for forming a common electrode on an upper portion of the planarization layer 525 and then selectively patterning the metal layer (not illustrated) through the mask process using the photolithography technique. The common electrode 527 may be formed of a transparent conductive material or an opaque conductive material.

Then, the second interlayer insulation film 529 may be formed on the upper portion of the planarization layer 525 including the common electrode 527. Here, the second interlayer insulation film 529 may also be formed on exposed portions of the first interlayer insulation film 522 and etch stopper 523.

Next, the pixel electrode 531 may be formed by depositing a metal layer (not illustrated) for forming a pixel electrode, which is electrically connected to the drain electrode 518 of the thin film transistor T, on the upper portion of the second interlayer insulation film 529 and then selectively patterning the metal layer (not illustrated) through the mask process using a photolithography technique. The pixel electrode 531 may be connected to the drain electrode 518 through the drain contact hole (not illustrated) formed in the first interlayer insulation film 522, the planarization layer 525, and the second interlayer insulation film 529. In addition, during the process of forming the pixel electrode 531, the connection line 532 connected to the COG 520 and the pad part 521 may be formed together on the upper portion of the sub-glass substrate 512 located in the non-display area NDA. Here, the connection line 532 may be connected to the link lines 524, the COG 520, and the pad part 521 through the first interlayer insulation film 522 and the second interlayer insulation film 529 or through the contact hole (not illustrated) formed in the planarization layer 525 and the second interlayer insulation film 529.

Then, the opening 530 at which a portion of the second interlayer insulation film 529 located in the bending area BA is selectively removed and the planarization layer 525 is exposed may be formed. For example, when the second interlayer insulation film 529 is made of an inorganic material, and the second interlayer insulation film 529 made of an inorganic material is present in the bending area BA, cracks occur while the bending area BA is being bent. Therefore, since the cracks may spread toward the display area DA, a portion of the second interlayer insulation film 529 that is formed in the bending area BA may be removed to block the spreading of the cracks toward the display area DA.

Next, referring to FIG. 11B, an organic layer (not illustrated) for bump pattern forming may be deposited on the upper portion of the first glass substrate 510 including the exposed planarization layer 525. Here, the organic layer (not illustrated) may be formed on entire surfaces of the display area DA and the non-display area NDA of the first glass substrate 510.

The organic layer may include at least one of a silicone-based organic material, urethane, polyimide, and photo acryl. In addition, the organic layer may be made of an organic material having flexibility or elasticity to prevent an occurrence of cracks caused by stress while being bent. In addition, as will be described below, a column spacer formed on the second glass substrate 610 (see FIG. 11C) may also be made of the same material as the organic layer for forming a bump pattern. However, the present disclosure is not necessarily limited thereto.

Then, by selectively patterning the organic insulation layer by the exposure and development process using the photolithography technique, the bump pattern 535 may be formed in the opening 530 present on the upper portion of the planarization layer 525 on the etch stopper 523 located in the bending area BA.

Accordingly, since the bump pattern 535 is formed on the planarization layer 525 laminated on the upper portion of the etch stopper 523 overlapping the bending area BA, the bump pattern 535 can reinforce the thicknesses of organic layers laminated on the etch stopper 523.

Moreover, in a process of forming the bump pattern 535, the sub-bump pattern 537 may be formed together on the upper portion of the second interlayer insulation film 529 located on the upper portion of the thin film transistor T present in the display area DA. Here, the sub-bump pattern 537 may be disposed to overlap and come into contact with the column spacer 621 (see FIG. 11C) disposed on the second glass substrate 610 disposed to face the first glass substrate 510.

Next, the first alignment film (not illustrated) for easily inducing liquid crystal alignment may be formed at upper portions of the bump pattern 535, the sub-bump pattern 537, the pixel electrode 531, and the second interlayer insulation film 529. However, the present disclosure is not limited thereto.

Then, referring to FIG. 11C, the second glass substrate 610 disposed to correspond to the first glass substrate 510 of the display area DA while having a predetermined cell gap therebetween may be prepared.

Next, the black matrices 613 may be disposed at a predetermined interval on the second glass substrate 610 located in the display area DA.

The black matrices 613 may have a closed loop shape surrounding the display area DA to block light leakage. In addition, the black matrices 613 may also correspond to areas corresponding to the thin film transistor T, the gate line (not illustrated), and the data line (not illustrated) of the first glass substrate 510 to block light leakage. Moreover, the black matrices 613 may be provided between the red, green, and blue color filter layers 615, 617, and 619 to prevent color mixture between the color filter layers 615, 617, and 619.

Then, the red (R), green (G), and blue (B) color filter layers 615, 617, and 619 each configured to filter only light of a specific wavelength band may be disposed between the black matrices 613. The color filter layers 615, 617, and 619 may each include an acryl resin and a pigment. The color filter layers 615, 617, and 619 may be classified into red (R), green (G), and blue (B) according to the type of pigment implementing the colors.

Here, a support pattern forming material layer (not illustrated) configured to prevent an occurrence of collapse of the bump pattern 535 caused by performing etching of the bending area BA may be formed on the upper portion of the second glass substrate 610 located in the non-display area NDA. The support pattern forming material layer may be formed of the same material as the color filter layers or the black matrices. However, the present disclosure is not limited thereto.

Next, the support pattern 625 may be formed by selectively removing the support pattern forming material layer by the exposure and development process using the photolithography technique. Here, the support pattern 625 may also be fabricated when forming the color filter layers 615, 617, and 619 or the black matrices 613.

Accordingly, when bonding the first and second glass substrates 510 and 610, the support pattern 625 may overlap and come into contact with the upper surface of the bump pattern 535 disposed on the first glass substrate 510 and thereby firmly support the bump pattern 535.

Next, the overcoat layer (not illustrated) may be further formed on the black matrices 613 and the color filter layers 615, 617, and 619. The overcoat layer (not illustrated) may be provided to protect the color filter layers 615, 617, and 619 and improve adhesion through surface planarization of the color filter layers 615, 617, and 619 and may be made of an acrylic resin.

Then, the second alignment film (not illustrated) may be formed on the upper portion of the overcoat layer (not illustrated) to easily induce liquid crystal alignment.

Next, the column spacer 621 may be disposed to overlap an area of the thin film transistor T of the first glass substrate 510 disposed to face the second glass substrate 610 at a predetermined gap on an upper portion of the second alignment film (not illustrated). Here, the column spacer 621 may be disposed to come into contact with the upper surface of the above-described sub-bump pattern 537.

Then, the seal line 623 may be disposed in the non-display area NDA of the first glass substrate 510 and the second glass substrate 610. Here, the first and second glass substrates 510 and 610 may be bonded by the seal line 623.

The seal line 623 may be provided on the second interlayer insulation film 529 while spaced apart from the first alignment film (not illustrated) and may be disposed to face the second interlayer insulation film 529 and the black matrices 613. The seal line 623 may be made of a sealant. For example, the sealant may be a photocurable or thermosetting epoxy resin. The seal line 623 serves to form a gap for liquid crystal injection and prevent leakage of injected liquid crystals.

Next, by the seal line 623, an LCD device is configured by forming a thermosetting resin of a predetermined pattern on the first glass substrate 510, placing the second glass substrate 610 on the first glass substrate 510, and then pressing and curing the two substrates 510 and 610 to bond the two substrates 510 and 610. However, the present disclosure is not limited thereto.

Then, an area in which a predetermined cell gap is formed between the first glass substrate 510 and the second glass substrate 610 may be filled with the liquid crystal layer 630. The liquid crystal layer 630 may include liquid crystals having an optical anisotropic characteristic.

The display device 500 according to still another embodiment of the present disclosure may display a desired image by driving liquid crystal cells using a data voltage supplied to the pixel electrode 531 and a common voltage supplied to the common electrode 527 to adjust light transmittance of the liquid crystal cells.

Next, after the process of fabricating the LCD device is completed, a process of etching portions of the first glass substrate 510 and the sub-glass substrate 512 located in the bending area BA may be performed to expose a lower portion of the etch stopper 523.

Through such an etching process, the first etching surface 510b and the second etching surface 512b may be formed on the first glass substrate 510 and the sub-glass substrate 512, respectively, that are located below both side surfaces of the etch stopper 523.

Here, “the first etching surface 510b overlaps the bending area BA” may mean that the first etching surface 510b faces a rear surface of the etch stopper 523 that overlaps the bending area BA. In addition, since the display device has a structure that cannot be bent when the first etching surface 510b is not provided in the bending area BA of the display device, the bending area BA of the display device may be defined as overlapping the first etching surface 510b.

Moreover, the first glass substrate 510 may include the first upper surface 510a and the first etching surface 510b disposed on one side of the first upper surface 510a and may further include the first lower surface 510c facing the first upper surface 510a.

Although the first etching surface 510b is illustrated as having an inclined tapered surface, the embodiment of the present disclosure is not limited thereto.

In addition, the sub-glass substrate 512 divided from the first glass substrate 510 due to etching of the first glass substrate 510 may include the second etching surface 512b provided to overlap the bending area BA. Here, “the second etching surface 512b overlaps the bending area BA” may mean that the second etching surface 512b faces a rear surface of the sub-glass substrate 512 that overlaps the second etching surface 512b.

Moreover, the sub-glass substrate 512 may include the second upper surface 512a and the second etching surface 512b disposed on one side of the second upper surface 512a and may further include the second lower surface 512c facing the second upper surface 512a.

The first etching surface 510b of the first glass substrate 510 and the second etching surface 512b of the sub-glass substrate 512 may be referred to as having a reverse-tapered shape or an undercut structure when formed as shown in FIG. 10.

In this way, in the display device according to still another embodiment of the present disclosure, since a bump pattern is formed on a planarization film disposed on upper portions of an etch stopper and a link line on a first glass substrate, and a support pattern is additionally formed on a second glass substrate to overlap and come into contact with the bump pattern to further reinforce a thickness of an organic layer, it is possible to prevent an occurrence of cracks in lines and prevent damage to the etch stopper caused by an external force when etching is performed on a glass substrate present in a bending area.

Meanwhile, a bending structure of a display device according to one embodiment of the present invention will be described in detail with reference to FIG. 12.

FIG. 12 is a cross-sectional view of a display device in which a bending area is bent according to one embodiment of the present disclosure.

Referring to FIG. 12, the display device 100 according to one embodiment of the present disclosure may include the first glass substrate 110 and the second glass substrate 210 vertically disposed to face each other at a predetermined gap in the display area DA, and the sub-glass substrate 112 disposed to face the lower surface of the first glass substrate 110 while the bending area BA is disposed therebetween.

Here, the thin film transistor T, a gate line, a data line, and the pixel electrode 131 may be disposed on the upper portion of the first upper surface 110a of the first glass substrate 110.

Moreover, the red, green, and blue color filter layers 215, 217, and 219 may be disposed on an upper portion of the second glass substrate 210 that is a color filter array substrate disposed to face the first glass substrate 110, which is a thin film transistor array substrate, at a predetermined gap.

In addition, the liquid crystal layer 230 (see FIG. 3) may be filled between the first glass substrate 110 and the second glass substrate 210 located in the display area DA. Moreover, the light source part 250 (see FIG. 12) configured to emit light toward the upper portion of the first glass substrate 110 may be disposed between the first glass substrate 110 and the sub-glass substrate 112 disposed to face the lower portion of the first glass substrate 110 through bending of the bending area BA.

The non-display area NDA is an area surrounding the display area DA, and a device and a circuit line for driving the display area DA may be disposed in the non-display area NDA.

The bending area BA may be defined as an area provided to allow one portion of the display device 100 to be bent. Accordingly, the display device 100 according to one example of the present disclosure may be folded to have a predetermined radius of curvature according to the bending of the bending area BA.

Moreover, the display device 100 according to one embodiment of the present disclosure may be defined by a flat area FA including the display area DA and a portion of the non-display area NDA, the bending area BA, and a rear flat area RFA including the non-display area NDA.

The flat area FA may be defined as an area that overlaps the first upper surface 110a of the first glass substrate 110. In addition, the flat area FA may be an area that overlaps the display area DA and a portion of the non-display area NDA and includes a predetermined non-display area NDA surrounding the display area DA.

The bending area BA may include the etch stopper 123, the plurality of link lines 124, and the bump pattern 135, which are disposed on the first glass substrate 110.

In addition, a first coating layer 240 may be formed on the lower surface of the etch stopper 123 that is located between the first etching surface 110b of the first glass substrate 110 and the second etching surface 112b of the sub-glass substrate 112, which are bent.

A second coating layer 270 may be formed on an upper portion of the bump pattern 135 located in the bending area BA to cover configurations exposed to the outside together with the bump pattern 135. The second coating layer 270 may be formed to cover the seal line 223 or surround side surfaces thereof.

The first and second coating layers 240 and 270 (micro-coating layers) may be formed on upper portions of the first glass substrate 110, the sub-glass substrate 112, the link lines 124, and the etch stopper 123 in the bending area BA and the rear flat area RFA.

While the first glass substrate 110 and the sub-glass substrate 112 are being bent, a tensile force may act on the link lines 124 disposed on the etch stopper 123 and cracks may occur. However, in the present embodiment, the first and second coating layers 240 and 270 are disposed at positions where the first glass substrate 110 and the sub-glass substrate 112 are bent, that is, the bending area BA, and thus may protect the link lines 124. In addition, the first and second coating layers 240 and 270 may be made of an acrylic material such as an acrylate polymer. However, the present disclosure is not limited thereto.

Moreover, the first and second coating layers 240 and 270 may adjust a neutral plane of the bending area BA. A neutral plane may refer to a virtual plane at which a compressive force and a tensile force applied to a structure when the structure is bent are offset by each other, and thus there is no stress. When two or more structures are stacked, a virtual neutral plane may be formed between the structures.

When all the structures are bent in one direction, structures disposed in the bending direction relative to the neutral plane are compressed due to being bent, and thus receive a compressive force. Conversely, structures disposed in the opposite direction of the bending direction relative to the neutral plane are stretched due to being bent, and thus receive a tensile force. In addition, since the structures are more vulnerable to the tensile force when the magnitudes of the compressive force and the tensile force are the same, the likelihood of an occurrence of cracks is higher when the structures receive the tensile force.

The etch stopper 123 disposed at a lower portion relative to the neutral plane may be compressed and thus receive a compressive force, the link line 124 disposed at an upper portion relative to the neutral plane may receive a tensile force, and due to the tensile force, cracks may occur. Therefore, the link line 124 may be located on the neutral plane to minimize the tensile force that the line receives.

Moreover, the light source part 250 may be disposed between the first glass substrate 110 and the sub-glass substrate 112 that is bent. As a light source of the light source part 250, a backlight unit, a micro-LED (μ-LED), or another light source may be used. However, the present disclosure is not limited thereto.

An adhesive layer 260 may be disposed on an adhesive portion between the light source part 250 and the first glass substrate 110 and between the light source part 250 and the sub-glass substrate 112 that is bent. As a result, the light source part 250 may be firmly fixed between the first glass substrate 110 and the sub-glass substrate 112. However, the present disclosure is not limited thereto, and a fixing member other than the adhesive layer 260 may be used.

In this way, in the display device according to the present disclosure, since a bump pattern is formed on a planarization layer laminated on an upper portion of an etch stopper that overlaps a bending area, a thickness of an organic layer laminated on the etch stopper can be reinforced.

As a result, according to the present disclosure, by forming the bump pattern on the planarization layer laminated on upper portions of link lines and reinforcing the thickness of the organic layer, an occurrence of cracks in the link lines on the etch stopper can be prevented, and damage to the etch stopper caused by an external force can be prevented.

According to the present disclosure, a thickness of an organic layer is reinforced by forming a bump pattern on a planarization film disposed on upper portions of an etch stopper and a link line. In this way, when etching is performed on a glass substrate present in a bending area, an occurrence of cracks in lines can be prevented, and damage to the etch stopper caused by an external force can be prevented or at least reduced.

The display device according to embodiments of the present disclosure may be applied to mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical apparatuses, desktop personal computers (PCs), laptop PCs, netbook computers, workstations, navigation apparatuses, automotive display apparatuses, theater displays, televisions (TVs), wallpaper apparatuses, signage apparatuses, notebook computers, monitors, cameras, camcorders, home appliances, and the like. In addition, a display device manufactured through a light-emitting element transfer stamp and a light-emitting element transfer method using a transfer stamp according to one or more embodiments of the present disclosure may be applied to an organic light-emitting lighting device or an inorganic light-emitting lighting device.

A display device according to one or more embodiments of the present disclosure may be described as follows.

A display device according to one or more embodiments of the present disclosure may comprise a first substrate including a display area and a non-display area having a bending area, a second substrate disposed apart from the first substrate in the display area, a sub-substrate disposed to face a lower portion of the first substrate while the bending area of the non-display area is disposed therebetween, an etch stopper disposed on the first substrate and the sub-substrate to overlap the bending area, a link line disposed on an upper portion of the etch stopper, and a bump pattern disposed on an upper portion of the link line.

The display device may further include a planarization layer disposed between the link line and the bump pattern.

The bump pattern may include a first bump pattern and a second bump pattern disposed apart from each other on an upper portion of the planarization layer.

The display device may further include a reinforcing pattern disposed between the first bump pattern and the second bump pattern.

The reinforcing pattern may have a thickness greater than or equal to a height of each of the first and second bump patterns.

A support pattern in contact with the bump pattern may be disposed on an upper portion of the second substrate that overlaps the bump pattern.

The display device may further include a thin film transistor disposed on the first substrate in the display area, a pixel electrode connected to the thin film transistor, a color filter layer disposed on the second substrate in the display area, a seal line disposed between the first substrate and the second substrate that are located in the non-display area, a liquid crystal layer disposed between the first substrate and the second substrate in the display area and disposed at an inner side of the seal line, a sub-bump pattern disposed on the planarization layer on an upper portion of the thin film transistor, and a column spacer disposed on the second substrate that overlaps the sub-bump pattern.

The bending area may include a lower surface of the etch stopper, a first etching surface provided on a side surface of the first substrate, and a second etching surface provided on a side surface of the sub-substrate.

The bump pattern may include an organic material.

The reinforcing pattern may be made of an organic material or made of the same organic layer as the seal line.

The display device may further include a first coating layer disposed on a lower portion of the etch stopper between the first etching surface of the first substrate and the second etching surface of the sub-substrate, and a second coating layer disposed on an upper portion of the bump pattern.

The display device may further include a light source part disposed between the first substrate and the sub-substrate located to face the lower portion of the first substrate when the bending area is bent.

A display device according to one or more embodiments of the present disclosure may comprise a first substrate including a display area and a non-display area having a bending area, a second substrate disposed apart from the first substrate in the display area, a liquid crystal layer disposed between the first and second substrates in the display area, a sub-substrate divided from the first substrate while the bending area is disposed therebetween, an etch stopper disposed on the first substrate and the sub-substrate that overlap the bending area, a link line disposed on an upper portion of the etch stopper, a planarization layer disposed on an upper portion of the link line, and a bump pattern disposed on an upper portion of the planarization layer.

The bump pattern may include a first bump pattern and a second bump pattern disposed apart from each other at a predetermined interval on an upper portion of the planarization layer.

The display device may further include a reinforcing pattern disposed between the first bump pattern and the second bump pattern.

The reinforcing pattern may have a thickness greater than or equal to a height of each of the first and second bump patterns.

A support pattern in contact with the bump pattern may be disposed on an upper portion of the second substrate that overlaps the bump pattern.

The display device may further include a thin film transistor disposed on the first substrate in the display area, a pixel electrode connected to the thin film transistor, a color filter layer disposed on the second substrate in the display area, a seal line disposed between the first substrate and the second substrate that are located in the non-display area, a sub-bump pattern disposed on the planarization layer at an upper portion of the thin film transistor, and a column spacer disposed on the second substrate that overlaps the sub-bump pattern.

The bending area may include a lower surface of the etch stopper, a first etching surface provided on a side surface of the first substrate, and a second etching surface provided on a side surface of the sub-substrate.

The display device may further include a first coating layer disposed on a lower portion of the etch stopper between the first etching surface of the first substrate and the second etching surface of the sub-substrate, and a second coating layer disposed on an upper portion of the bump pattern.

The effects of the present disclosure are not limited to the effects mentioned above, and other effects not mentioned may be clearly understood by those skilled in the art from the description of the claims.

While the embodiments have been described in detail above with reference to the accompanying drawings, the present disclosure is not necessarily limited to these embodiments, and various changes and modifications may be made without departing from the technical spirit of the present invention. Accordingly, the embodiments disclosed herein are to be considered descriptive and not restrictive of the technical spirit of the present disclosure, and the scope of the technical spirit of the present disclosure is not limited by these embodiments. Therefore, the above-described embodiments should be understood to be exemplary and not limiting in any aspect.

What is claimed is:

1. A display device comprising:
a first substrate including a display area and a non-display area having a bending area;
a second substrate spaced apart from the first substrate in the display area, a sub-substrate that faces a lower portion of the first substrate while the bending area of the non-display area is disposed therebetween;
an etch stopper on the first substrate and the sub-substrate, the etch stopper overlapping the bending area;
a link line on an upper portion of the etch stopper; and
a bump pattern on an upper portion of the link line.

2. The display device of claim 1, further comprising:
a planarization layer between the link line and the bump pattern.

3. The display device of claim 2, wherein the bump pattern includes a first bump pattern and a second bump pattern that are spaced apart from each other on an upper portion of the planarization layer.

4. The display device of claim 3, further comprising:
a reinforcing pattern between the first bump pattern and the second bump pattern.

5. The display device of claim 4, wherein the reinforcing pattern has a thickness that is greater than or equal to a height of each of the first bump pattern and the second bump pattern.

6. The display device of claim 2, wherein a support pattern in contact with the bump pattern is on an upper portion of the second substrate that overlaps the bump pattern.

7. The display device of claim 4, further comprising:
a thin film transistor on the first substrate in the display area;
a pixel electrode connected to the thin film transistor;
a color filter layer on the second substrate in the display area;
a seal line between the first substrate and the second substrate that are located in the non-display area;
a liquid crystal layer between the first substrate and the second substrate in the display area and at an inner side of the seal line;
a sub-bump pattern on the planarization layer on an upper portion of the thin film transistor; and
a column spacer on the second substrate that overlaps the sub-bump pattern.

8. The display device of claim 1, wherein the bending area includes a lower surface of the etch stopper, a first etching surface on a side surface of the first substrate, and a second etching surface on a side surface of the sub-substrate.

9. The display device of claim 1, wherein the bump pattern includes an organic material.

10. The display device of claim 7, wherein the reinforcing pattern includes an organic material or a same organic layer as the seal line.

11. The display device of claim 8, further comprising:
a first coating layer on a lower portion of the etch stopper between the first etching surface of the first substrate and the second etching surface of the sub-substrate; and
a second coating layer on an upper portion of the bump pattern.

12. The display device of claim 1, further comprising:
a light source part between the first substrate and the sub-substrate located, the light source part facing the lower portion of the first substrate when the bending area is bent.

13. The display device of claim 7, wherein the bump pattern includes an organic material that is identical to a material included in the column spacer.

14. The display device of claim 6, further comprising:
black matrices disposed at predetermined intervals on the second substrate located in the display area,
wherein the support pattern includes an organic material or includes a same material as the black matrices.

15. The display device of claim 14, wherein the black matrices have a closed loop shape surrounding the display area to block light leakage.

16. The display device of claim 1, wherein the link line covers one side surface of the etch stopper.

17. The display device of claim 8, wherein the etch stopper has a larger size than areas overlapping the first etching surface and the second etching surface or has a larger size than an area of the bending area.

18. The display device of claim 8, wherein the first etching surface and the second etching surface have a reverse-tapered shape or an undercut structure.

19. The display device of claim 1, wherein the etch stopper overlaps a first upper surface of the first substrate that extends to one side of the bending area and overlaps a second upper surface of the sub-substrate that extends to another side of the bending area.

20. The display device of claim 11, wherein the first coating layer and the second coating layer are disposed in the bending area.

21. A display device comprising:
a first substrate including a display area and a non-display area having a bending area;
a second substrate spaced apart from the first substrate in the display area;
a liquid crystal layer between the first substrate and the second substrate in the display area;
a sub-substrate divided from the first substrate while the bending area is disposed therebetween;
an etch stopper on the first substrate and the sub-substrate that overlap the bending area;
a link line on an upper portion of the etch stopper;
a planarization layer on an upper portion of the link line; and
a bump pattern on an upper portion of the planarization layer.

22. The display device of claim 21, wherein the bump pattern includes a first bump pattern and a second bump pattern that are spaced apart from each other at a predetermined interval on an upper portion of the planarization layer.

23. The display device of claim 22, further comprising:
a reinforcing pattern between the first bump pattern and the second bump pattern.

24. The display device of claim 23, wherein the reinforcing pattern has a thickness that is greater than or equal to a height of each of the first bump pattern and the second bump pattern.

25. The display device of claim 21, wherein a support pattern in contact with the bump pattern is on an upper portion of the second substrate that overlaps the bump pattern.

26. The display device of claim 21, further comprising:
a thin film transistor on the first substrate in the display area;
a pixel electrode connected to the thin film transistor;
a color filter layer on the second substrate in the display area;
a seal line between the first substrate and the second substrate that are located in the non-display area;
a sub-bump pattern on the planarization layer at an upper portion of the thin film transistor; and
a column spacer on the second substrate that overlaps the sub-bump pattern.

27. The display device of claim 21, wherein the bending area includes a lower surface of the etch stopper, a first etching surface on a side surface of the first substrate, and a second etching surface on a side surface of the sub-substrate.

28. The display device of claim 27, further comprising:
a first coating layer on a lower portion of the etch stopper between the first etching surface of the first substrate and the second etching surface of the sub-substrate; and
a second coating layer on an upper portion of the bump pattern.

29. The display device of claim 27, wherein the first etching surface and the second etching surface have a reverse-tapered shape or an undercut structure.

30. The display device of claim 28, wherein the first coating layer and the second coating layer are in the bending area.
